(19) United States
(12) Patent Application Publication
(10) Pub. No.: US 2025/0280050 A1
(43) Pub. Date: Sep. 4, 2025

(54) WORKLOAD SCHEDULING IN EDGE COMPUTING

(71) Applicant: QUALCOMM Incorporated, San Diego, CA (US)

(72) Inventors: Yuyang WANG, Pflugerville, TX (US); Qi XUE, San Diego, CA (US)

(21) Appl. No.: 18/591,963

(22) Filed: Feb. 29, 2024

(51) Int. Cl. H04L 67/1008; H04L 67/101

(52) U.S. Cl. CPC H04L 67/1008; H04L 67/101

(57) ABSTRACT

This disclosure provides methods, components, devices and systems for workload scheduling in edge computing. Some aspects more specifically relate to workload scheduling in distributed computing scenarios, which may include various devices including one or more workload scheduler devices, one or more host devices, and one or more client devices. A workload scheduler device may receive a workload request from a client device and may assign the workload to a host device from a set of host devices, with such a set of host devices including host devices capable of satisfying expectations of the workload. To assign the workload, the workload scheduler device may perform joint evaluations for the set of host devices, obtain scores for the set of host devices in accordance with the joint evaluations, rank the set of host devices in accordance with their respective scores, and assign the workload to the host device having the greatest ranking.

### TECHNICAL FIELD

This disclosure relates generally to wireless communication, and more specifically, to workload scheduling in edge computing.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-s-OFDM). A wireless multiple-access communication system may include one or more base stations (BSs) or one or more network access nodes, each simultaneously supporting communication for multiple communication devices, which may be otherwise known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a workload scheduler device. The workload scheduler device may include a processing system that includes processor circuitry and memory circuitry that stores code. The processing system may be configured to cause the workload scheduler device to receive, via a request associated with a workload, information indicative of one or more parameters associated with the workload and to transmit an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in a method for connected edge workload scheduling by or at a workload scheduler device. The method may include receiving, via a request associated with a workload, information indicative of one or more parameters associated with the workload and transmitting an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in a workload scheduler device. The workload scheduler device may include means for receiving, via a request associated with a workload, information indicative of one or more parameters associated with the workload and means for transmitting an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in a non-transitory computer-readable medium storing code for connected edge workload scheduling by or at a workload scheduler device. The code may include instructions executable by a processing system (such as one or more processors) to receive, via a request associated with a workload, information indicative of one or more parameters associated with the workload and transmit an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Some implementations of the method, workload scheduler devices, and non-transitory computer-readable medium described herein may further include operations, features, means, or instructions for receiving, from the first host device, information associated with the first set of one or more computation metrics, the first set of one or more communication metrics, the first set of one or more power supply metrics, and the first set of one or more reliability metrics.

Some implementations of the method, workload scheduler devices, and non-transitory computer-readable medium described herein may further include operations, features, means, or instructions for obtaining a set of scores for a set of host devices including the first host device in accordance with a respective joint evaluation associated with each host device of a set of host devices, where each score of the set of scores may be for a respective host device of the set of host devices, and where the assignment of the workload to at least the first host device may be in accordance with a first score for the first host device being relatively greater than one or more scores for a remainder of the set of host devices excluding the first host device.

Some implementations of the method, workload scheduler devices, and non-transitory computer-readable medium described herein may further include operations, features, means, or instructions for obtaining a set of host devices from a set of multiple host devices in association with evaluating each host device of the set of multiple host devices in accordance with the one or more parameters and one or more variants of the workload, where the set of host devices includes the first host device.

In some implementations of the method, workload scheduler devices, and non-transitory computer-readable medium described herein, evaluating each host device of the set of multiple host devices may include operations, features, means, or instructions for evaluating whether the workload may be feasible for a respective host device of the set of multiple host devices in accordance with the one or more parameters, a respective set of one or more variants of the workload, and a capability of the respective host device.

Another innovative aspect of the subject matter described in this disclosure can be implemented in a first host device. The first host device may include a processing system that includes processor circuitry and memory circuitry that stores code. The processing system may be configured to cause the first host device to transmit, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device and receive, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Another innovative aspect of the subject matter described in this disclosure can be implemented in a method for connected edge workload scheduling by or at a first host device. The method may include transmitting, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device and receiving, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Another innovative aspect of the subject matter described in this disclosure can be implemented in a first host device. The first host device may include means for transmitting, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device and means for receiving, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Another innovative aspect of the subject matter described in this disclosure can be implemented in a non-transitory computer-readable medium storing code for connected edge workload scheduling by or at a first host device. The code may include instructions executable by a processing system (such as one or more processors) to transmit, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device and receive, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Some implementations of the method, first host devices, and non-transitory computer-readable medium described herein may further include operations, features, means, or instructions for transmitting, to the workload scheduler device, a rejection of the assignment of the workload to the first host device in accordance with one or more percentage metrics associated with an amount of resources used for one or more edge compute workloads, including the workload, at the first host device exceeding one or more threshold percentages.

Some implementations of the method, first host devices, and non-transitory computer-readable medium described herein may further include operations, features, means, or instructions for receiving, from the workload scheduler device, an indication of a suspension of workload requests associated with a session-oriented workload type in accordance with one or more network congestion metrics.

Some implementations of the method, first host devices, and non-transitory computer-readable medium described herein may further include operations, features, means, or instructions for transmitting, to the workload scheduler device, information indicative of one or more network congestion metrics associated with a cluster of edge devices including the first host device.

Some implementations of the method, first host devices, and non-transitory computer-readable medium described herein may further include operations, features, means, or instructions for receiving, from the workload scheduler device, an indication of a suspension of workload requests in accordance with a preemption rate associated with workloads assigned to a cluster of edge devices including the first host device exceeding a threshold preemption rate.

Another innovative aspect of the subject matter described in this disclosure can be implemented in a client device. The client device may include a processing system that includes processor circuitry and memory circuitry that stores code. The processing system may be configured to cause the client device to transmit, via a request associated with a workload, information indicative of one or more parameters associated with the workload and receive information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in a method for connected edge workload scheduling by a client device. The method may include transmitting, via a request associated with a workload, information indicative of one or more parameters associated with the workload and receiving information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in client device. The client device may include means for transmitting, via a request associated with a workload, information indicative of one or more parameters associated with the workload and means for receiving information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Another innovative aspect of the subject matter described in this disclosure can be implemented in a non-transitory computer-readable medium storing code for connected edge workload scheduling by or at a client device. The code may include instructions executable by a processing system (such as one or more processors) to transmit, via a request associated with a workload, information indicative of one or more parameters associated with the workload and receive information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Some implementations of the method, client devices, and non-transitory computer-readable medium described herein may further include operations, features, means, or instructions for receiving, from a workload scheduler device, an indication of a suspension of workload requests associated with a session-oriented workload type in accordance with one or more network congestion metrics.

Some implementations of the method, client devices, and non-transitory computer-readable medium described herein may further include operations, features, means, or instructions for receiving, from a workload scheduler device, an indication of a suspension of workload requests in accordance with a preemption rate associated with workloads assigned to a cluster of edge devices including the first host device exceeding a threshold preemption rate.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communication system that supports workload scheduling in edge computing.

FIG. 2 shows an example connected edge cluster architecture that supports workload scheduling in edge computing.

FIG. 3 shows an example signaling diagram that supports workload scheduling in edge computing.

FIG. 4A shows an example workload scheduling diagram that supports workload scheduling in edge computing.

FIG. 4B shows an example nested workload scheduling algorithm that supports workload scheduling in edge computing.

FIG. 5 shows an example workload deployment algorithm that supports workload scheduling in edge computing.

FIG. 6 shows an example filtering procedure that supports workload scheduling in edge computing.

FIG. 7 shows an example scoring hierarchy that supports workload scheduling in edge computing.

FIG. 8 shows an example scoring adaptation algorithm that supports workload scheduling in edge computing.

FIG. 9 shows an example process flow that supports workload scheduling in edge computing.

FIGS. 10 and 11 show block diagrams of example devices that support workload scheduling in edge computing.

FIGS. 12-14 show flowcharts illustrating example methods that support workload scheduling in edge computing.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G), fifth generation (5G), or sixth generation (6G), or further implementations thereof, technology.

Various aspects relate generally to assigning an edge compute workload to a host device. Some aspects more specifically relate to workload scheduling (such as workload assignments) in distributed computing scenarios, which may include various devices including one or more workload scheduler devices, one or more host devices, and one or more client devices. As described herein, “client” and “host” may be understood as logical roles of a device in a context of a workload assignment (such as a workload deployment). For example, a client device for a first workload may be a host device for a second workload. In other words, a device may serve, function, or operate as a host device or a client device on a per workload basis. In some implementations, a workload scheduler device may receive a workload request from a first device (which may be referred to herein as a client device for that workload request) and may assign the workload to a second device (which may be referred to herein as a host device for that workload request) for processing, computing, or execution. In some aspects, the workload scheduler device may assign the workload to the second device from a set of candidate devices (which may be referred to herein as a set of candidate host devices for that workload request). The workload scheduler device may obtain the set of candidate devices, which also may be referred to herein as a feasible host set, in accordance with determining, identifying, ascertaining, calculating, or otherwise receiving information indicating that each device of the set of candidate devices is capable of satisfying expectations associated with the requested workload. In other words, the workload scheduler device may obtain the feasible host set by filtering out potential host devices that are incapable of satisfying the expectations associated with the requested workload.

In accordance with obtaining the feasible host set, the workload scheduler device may perform one or more joint evaluations in association with assigning the requested workload. For example, the workload scheduler device may perform a respective joint evaluation for each device within the feasible host set. In other words, the workload scheduler device may perform a first joint evaluation for (such as associated with or corresponding to) a first device within the feasible host set, a second joint evaluation for (such as associated with or corresponding to) a second device within the feasible host set, and so on. Each joint evaluation may be a joint evaluation of one or more computation metrics, one or more communication metrics, one or more power supply metrics, and one or more reliability metrics. For example, the first joint evaluation may be a joint evaluation of a first set of one or more computation metrics associated with the first device, a first set of one or more communication metrics associated with the first device, a first set of one or more power supply metrics associated with the first device, and a first set of one or more reliability metrics associated with the first device. Further, each joint evaluation may be associated with (such as informed or conditioned by) one or more parameters associated with the requested workload.

The workload scheduler device may obtain a respective score for each device within the feasible host set in accordance with performing the joint evaluations. For example, the workload scheduler device may obtain a first score for the first device in accordance with the first joint evaluation and may obtain a second score for the second device in accordance with the second joint evaluation. The workload scheduler device may rank the first device and the second device in accordance with the first score and the second score, respectively. In some implementations, the workload scheduler device may obtain the scores from the joint evaluations as weighted scores. In such implementations, the workload scheduler device may apply one or more weights to one or more of the computation metric(s), communication metric(s), power supply metric(s), and reliability metric(s) as part of each joint evaluation. For example, for each joint evaluation, the workload scheduler device may apply a first weighting to the computation metric(s), a second weighting to the communication metric(s), a third weighting to the power supply metric(s), and a fourth weighting to the reliability metric(s). The first weighting, the second weighting, the third weighting, and the fourth weighting may be the same, partially the same, or different. For example, two or more of the weightings may be the same, two or more of the weightings may be different, or any combination thereof. In some aspects, the workload scheduler device may employ a learning capability or algorithm, such as via an artificial intelligence (AI) or machine learning (ML) model, to calculate, select, identify, or otherwise determine the weighting(s) for the joint evaluations. The workload scheduler device may provide such an AI or ML model with inputs of historical data associated with workload scheduling (such as via one or more workload logs) or user- or application-specific prioritizations (of, for example, one metric type over another), among other examples.

The workload scheduler device may assign the requested workload to a device from the feasible host set in accordance with the scores and the ranking of the devices within the feasible host set. For example, the workload scheduler device may assign the requested workload to the first device if the first score for the first device is relatively greater than a score for any other device within the feasible host set. In accordance with receiving an assignment of the requested workload, the first device (which may be a host device for the requested workload) may process the requested workload and return (such as transmit or otherwise provide) information associated with (such as a result of) the requested workload to the requesting device (which may be a client device for the requested workload).

Particular implementations of the subject matter described in this disclosure can be implemented to realize one or more of the following potential advantages. For example, by supporting some of the example implementations, a workload scheduler device may be able to more fully consider (such as account for, factor in, or evaluate) criteria that is especially relevant for distributed computing scenarios (such as distributed connected edge compute deployment scenarios). More specifically, by jointly evaluating one or more computation metrics, one or more communication metrics, one or more power supply metrics, and one or more reliability metrics of each potential host device, the described techniques may be implemented to realize more dynamic, efficient, and suitable workload scheduling (such as assignment) as compared to other workload schedulers (as compared to workload schedulers unable to consider more than, for example, computation metrics). Such more dynamic, efficient, and suitable workload scheduling may relate to an assignment of a workload to a specific host device that is associated with a combination of computation capabilities, communication capabilities, power supply, and reliability that is relatively most compatible to a given set of parameters associated with the workload. For example, by considering reliability metrics (in addition to other metric types), the workload scheduler device may more frequently assign workloads to relatively more reliable devices, which may reduce the likelihood of an assigned workload being preempted at a host device (including in distributed computing scenarios associated with high dynamics and mobility). Further, by allocating workloads to suitable host devices considering the various metrics described herein, the described techniques may increase the likelihood of balancing resource usage across host devices and may support relatively more (such as a greater quantity of) workloads among a set of host devices (by way of more efficiently assigning workloads to different devices). Thus, the described techniques may increase the likelihood of an assigned host device being able to satisfy the parameters associated with the workload, which may support lower latency, higher data rates, service enhancements, and greater user experience, among other benefits.

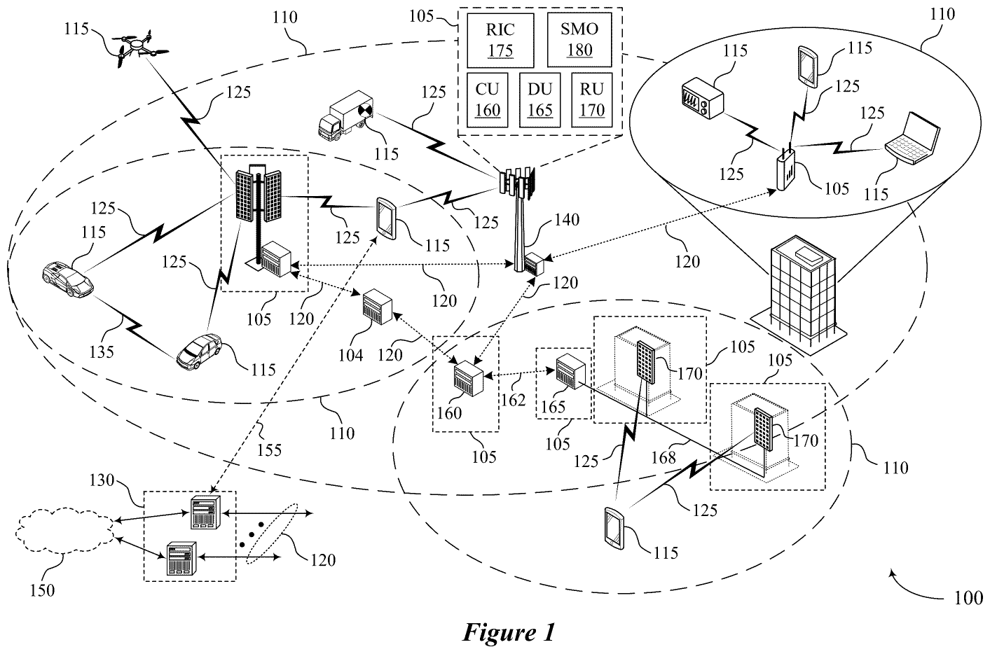

FIG. 1 shows an example wireless communication system 100 that supports workload scheduling in edge computing. The wireless communication system 100 may include one or more network entities 105, one or more UEs 115, and a core network 130. In some implementations, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a RAN node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communication system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1 c, F1 u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communication systems (such as wireless communication system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support workload scheduling in edge computing as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communication systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communication system 100 and may be referred to as a transmission time interval (TTI). In some implementations, the TTI duration (such as a quantity of symbol periods in a TTI) may be variable. Additionally, or alternatively, the smallest scheduling unit of the wireless communication system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other implementations, the overlapping coverage areas 110 associated with different technologies may be supported by different network entities 105. The wireless communication system 100 may include, for example, a heterogeneous network in which different types of the network entities 105 provide coverage for various coverage areas 110 using the same or different radio access technologies.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other implementations, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be in accordance with a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as a communication link 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, for which the device may provide HARQ feedback in a specific slot for data received via a previous symbol in the slot. In some other implementations, the device may provide HARQ feedback in a subsequent slot, or according to some other time interval.

Some UEs 115, such as MTC or IoT devices, may be low cost or low complexity devices and may provide for automated communication between machines (such as via Machine-to-Machine (M2M) communication). M2M communication or MTC may refer to data communication technologies that allow devices to communicate with one another or a network entity 105 (such as a BS 140) without human intervention. In some implementations, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some aspects, the wireless communication system 100 may support one or more signaling- or configuration-based mechanisms associated with workload scheduling in edge computing (such as in distributed computing scenarios). For example, the wireless communication system 100 may be an example of an edge computing system that includes a variety of devices, such as gNBs, APs, routers, mobile devices (smartphones), cars or other automobiles, laptops or other computing devices, gaming consoles, security cameras, wearable devices, extended reality (XR) or virtual reality (VR) glasses, augmented reality (AR) devices, smart thermostats, IoT devices, and other consumer devices connected to the network. These devices may serve as scheduler devices, host devices, client devices, or any two or more. Generally, a device may serve, operate, or function as a host device or a client device on a per workload basis. For example, a device may serve as a client device for a first workload and may serve as a host device for a second workload (sequentially, such as at different times, or in parallel, such as simultaneously). Additionally, or alternatively, in comparison to host devices (such as edge nodes), client devices may have fewer computing resources and relatively limited processing capabilities (at least, for example, as relevant for a particular workload, such that a device may request assignment of workloads for which the device is relatively poorly suited or for which assignment would otherwise result in greater processing speed or device performance). Thus, in some scenarios, a client device may rely on a host device to process, analyze, and execute relatively larger computing workloads (such as processing tasks, task workloads, or data services) that would otherwise result in delays and power consumption at the client device. Some client devices, such as security cameras, may process workloads locally instead of offloading such workloads to other devices. In some implementations, a workload or processing task may be associated with an output, which can include data, commands (such as to increase the temperature of a thermostat), alerts (such as a police alert), notifications (such as to a homeowner), or exporting data to the cloud for analysis or logging (such as video footage), etc.

In some edge computing systems, the collective workload of the edge computing system may be distributed across various nodes (such as edge nodes or devices) in the edge computing system (such as UEs 115 and network entities 105). Some edge computing systems may support compute resource management schemes for data centers, stationary compute nodes, and other devices. Such schemes may depend on communication links between devices having sufficient robustness and quality. However, these schemes may be unsuitable for mobile computing environments in which devices (such as cars, laptops, personal devices, and other compute nodes) move into the network, out of the network, or within the network at different times.

For example, in some mobile edge compute (MEC) deployments associated with cellular networks, a client device (such as a UE 115) may move between different network entities 105, resulting in changes to MEC latency criteria. Likewise, the topology of wireless communication links between host devices (such as edge nodes) and client devices may vary over time. Some edge computing deployments may be unable to account for device mobility when scheduling and distributing device workloads. For example, some transitory host devices (such as vehicles and automobiles, or mobile devices) may be unavailable during specific time periods and other host devices may be unable to adjust or redistribute task workloads according to the availability of transitory host devices. As described herein, a transitory host device may be a device or node with periodic, occasional, or intermittent availability, such that the transitory host device is temporarily available and otherwise unavailable for task processing or execution.

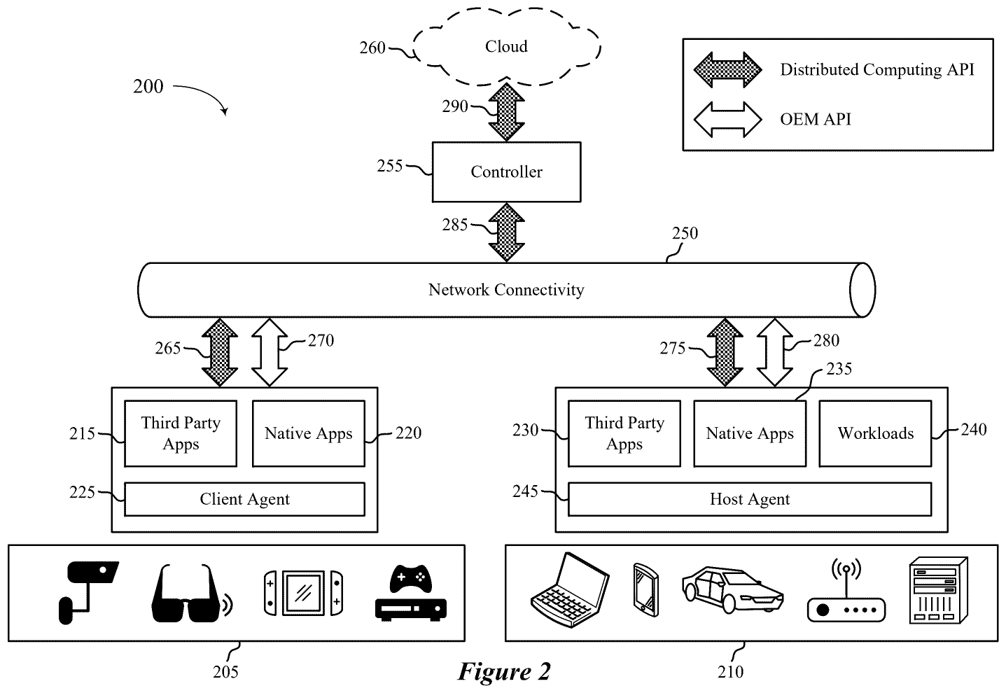

In some edge computing deployments, device workload distribution may be orchestrated (such as managed) by a cloud server or a data center. However, relying on cloud devices (such as a cloud edge 260 illustrated by and described with reference to FIG. 2) for workload management and task execution may introduce delays, privacy concerns, and backhaul issues. For example, due to an inverse relationship between locality (such as distance) and latency (such as processing time) that exists in distributed computing environments, executing a processing workload at a nearby host device may be more effective (with respect to latency) than offloading the processing task to a remote cloud server. Thus, relying on the cloud to execute workloads may introduce unacceptable delays and security issues. Moreover, cloud devices may be several hops away from host devices or edge nodes within the edge computing system, and may experience connectivity issues. Further, cloud devices may consider a limited subset of a larger set of relevant criteria associated workload assignments in edge computing deployments, which may result in unsuitable or inefficient workload assignment. For example, while multiple different criteria may inform workload assignment in edge computing deployments, cloud devices may consider computation metrics and lack capability to consider other metrics pertinent to workload assignments in edge computing deployments.

As an example, some schemes (such as Kubernetes schemes) associated with cloud workload orchestration may rely on cluster deployment over dedicated compute edge devices (which may not be available in some deployment scenarios) and may be unable to account for communication costs or a dynamic cluster topology (which may be especially impactful to overall performance in some deployment scenarios). Further, such schemes may lack non-containerized workload support and, in accordance with a reliance on dedicated compute edge devices, may not be suitable for heterogeneous (and non-Linux) device platforms. Additionally, such schemes may apply a heavy weight on edge devices with limited capabilities, which may be unsuitable or cause difficulties in scenarios in which edge devices are not exclusively available for edge computing tasks.

In some examples, host devices and client devices (such as one or more network entities 105 or one or more UEs 105, or any combination thereof) of the wireless communication system 100 may support distributed computing scenarios and a corresponding scheduling (such as workload assignment) scheme. In other words, the wireless communication system 100 may be associated with a distributed computing ecosystem and may leverage a distributed computing workload scheduler. In accordance with supporting the distributed computing scenarios, host devices or client devices may bring (such as support) intelligence and high performance distributed computing to a connected edge. In some examples, the host devices or client devices may use a common (such as a same) platform to collect and process data and to learn an environment and its usage. Further, the host devices may manage resources and orchestrate tasks for efficiency and enhanced user experience. In some aspects, the host devices may leverage a hardware agnostic platform with open protocols, application programming interfaces (APIs), and software to enable the distributed computing ecosystem. Additionally, or alternatively, the host devices may use protocols, APIs, and algorithms configured for hardware of a specific vendor (such as a specific manufacturer).

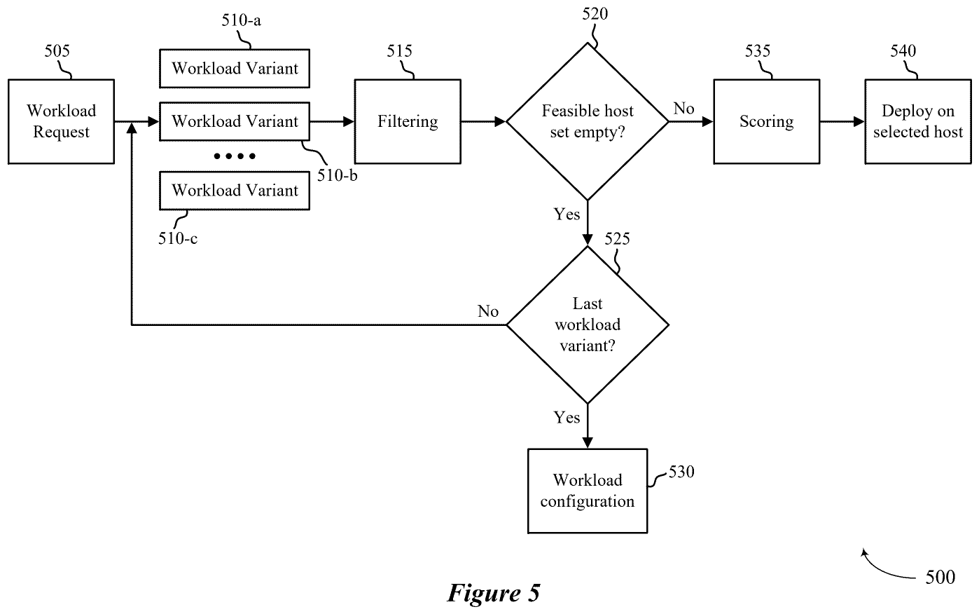

Aspects of the present disclosure support distributed computing workload scheduling (which may be equivalently referred to as distributed computing workload orchestration) that addresses (such as considers, involves, factors in, or otherwise accounts for) edge characteristics. In other words, some example implementations relate to a distributed computing workload scheduler that more fully considers unique aspects of workload scheduling for distributed computing as compared to other schemes. For example, while workload scheduling in the cloud may focus exclusively on computation metrics, a workload scheduler device implementing the described techniques may assign a workload to a host device in accordance with a joint evaluation of one or more computation metrics, one or more communication metrics, one or more power supply metrics, and one or more reliability metrics. In some implementations, the workload scheduler device may employ or otherwise use a workload deployment algorithm (such as a distributed computing workload deployment algorithm) to perform the joint evaluations of the computation metric(s), the communication metric(s), the power supply metric(s), and the reliability metric(s), as illustrated by and described in more detail with reference to FIG. 5.

Further, various aspects and techniques as described herein may be implemented, at least in part, using an AI program, such as a program that includes an ML or artificial neural network (ANN) model. An example ML model may include mathematical representations or define computing capabilities for making inferences from input data based on patterns or relationships identified in the input data. As used herein, the term “inferences” may include one or more of decisions, predictions, determinations, or values, which may represent outputs of the ML model. The computing capabilities may be defined in terms of one or more parameters of the ML model, such as weights and biases. Weights may indicate relationships between input data and outputs (such as between specific input data and specific outputs) of the ML model, and biases may be offsets that indicate a starting point for outputs of the ML model. An example ML model operating on input data may start at an initial output based on (such as in accordance with or otherwise associated with) the biases and (subsequently) update its output based on a combination of the input data and the weights.

In some aspects, an ML model may be configured to provide computing capabilities for wireless communications. In some implementations, a workload scheduler device may use such an ML model to select one or more weightings (such as biases) for one or more joint evaluations (such as to flexibly and dynamically adjust relative priority levels between various metric types for which the workload scheduler device may account). Thus, during operation of a device, the workload scheduler device may use different weights or biases when scheduling different types of workloads. For example, the workload scheduler device may use different weights or biases when scheduling an ML-based workload as compared to other types of compute workloads.

ML models may be deployed in one or more devices (such as network entities 105 and UEs 115) and may be configured to enhance various aspects of a wireless communication system. For example, an ML model may be trained to identify (or otherwise obtain) patterns or relationships in data corresponding to a network, a device, an air interface, or the like. An ML model may support operational decisions relating to one or more aspects associated with wireless communications devices, networks, or services. For example, an ML model may be utilized for supporting aspects such as workload assignments (including workload assignments in distributed computing scenarios), signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, or security, among other aspects.

ML models may be characterized in terms of types of learning that generate specific types of learned models that perform specific types of tasks. For example, different types of machine learning include supervised learning, unsupervised learning, semi-supervised learning, and reinforcement learning. ML models may be used to perform different tasks such as classification or regression, where classification refers to determining (such as obtaining, predicting, selecting, identifying, or otherwise ascertaining) one or more discrete output values from a set of predefined output values, and regression refers to determining (such as obtaining, predicting, selecting, identifying, or otherwise ascertaining) continuous values which are not bounded by predefined output values. For example, a classification ML model configured according to aspects of this disclosure may produce an output that includes an assignment of a workload to a specific host device (from a set of available (such as predefined, preselected, or previously obtained) host devices). Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network). Further, it should be understood that, unless otherwise specifically stated, terms such “AI/ML model,” “ML model,” “trained ML model,” “ANN,” “model,” “algorithm,” or the like are intended to be interchangeable.

FIG. 2 shows an example connected edge cluster architecture 200 that supports workload scheduling in edge computing. The connected edge cluster architecture 200 illustrates communication between client devices 205, host devices 210, and a distributed computing controller 255 via network connectivity 250. As described herein, a connected edge cluster (such as a cluster of devices associated with a distributed computing scenario) may be a group of locally connected edge devices (such as edge nodes) associated with a same administrator or user domain. A connected edge cluster may be equivalently referred to herein as a distributed computing local edge cluster, a distributed connected edge, or the like. In some implementations, one or more client devices 205, one or more host devices 210, or the distributed computing controller 255 may support distributed computing workload scheduling in accordance with one or more joint evaluations of potential or candidate host devices 210. In some aspects, a joint evaluation may be understood as being for (such as associated with or corresponding to) a given host device 210 and may be a joint evaluation of one or more computation metrics associated with that host device 210, one or more communication metrics associated with that host device 210, one or more power supply metrics associated with that host device 210, and one or more reliability metrics associated with that host device 210.

The client devices 205 may be examples of devices with relatively fewer processing capabilities or resources and the host devices 210 may be examples of devices with relatively more processing capabilities or resources. For example, the client devices 205 may be user devices, gaming consoles, gaming controllers or sensors, smart cameras, smart TVs, smart appliances (such as smart washers, dryers, refrigerators, freezers, microwaves, dishwashers, stoves, or ovens), XR or VR glasses or headsets, AR devices, smart watches, earbuds, smart thermostats, IoT devices, or any combination thereof. For further example, the host devices 210 may be laptops, mobile devices (smartphones), vehicles, servers, gNBs, APs, routers, or any combination thereof. Generally, devices such as gNBs, APs, UEs, mobile STAs, routers, mobile devices (smartphones), cars or other automobiles, laptops or other computing devices, gaming consoles, wearable devices, XR or VR glasses or headsets, AR devices, smart watches, earbuds, thermostats, sensors, IoT devices, and other consumer devices may serve as scheduler devices, host devices, client devices, or any two or more at different times. Further, although illustrated and described in examples as “host” devices and “client” devices, the various devices illustrated by and described with reference to FIG. 2 may serve, operate, or function as either a host device or a client device on a per workload basis.

The client devices 205 and the host devices 210 may be associated with (such as include, support, run, or otherwise perform operations via or in accordance with) one or more respective agents, components, functionalities, or applications. For example, a client device 205 may be associated with one or more third party applications 215 (such as third party distributed computing applications), one or more native applications 220 (such as native distributed computing applications), and a client agent 225 (such as a distributed computing client agent). A host device 210 may be associated with one or more third party applications 230 (such as third party distributed computing applications), one or more native applications 235 (such as native distributed computing applications), one or more workloads 240, and a host agent 245 (such as a distributed computing host agent). In some aspects, the distributed computing controller 255, which may include, function as, support, or otherwise be associated with a management and orchestration (MANO), may be an example of a workload scheduler device. In such aspects, the distributed computing controller 255 may perform one or more joint evaluations for (such as across, associated, or corresponding to) the set of host devices 210 and assign one or more workloads 240 to one or more host devices 210 in accordance with the one or more joint evaluations. The connected edge cluster architecture 200 may further include one or more legacy devices. In some aspects, such distributing computing components of the distributed computing controller 255, the host devices 210, the client devices 205, and the legacy devices may differentiate distributed computing deployments from Kubernetes components of a master node (supporting or be associated with a scheduler and one or more controllers) and a worker node (supporting or associated with a kubelet, which may be a node-level agent that is in charge of executing pod targets, managing resources, and supporting cluster health).

The network connectivity 250 via which client devices 205, host devices 210, and the distributed computing controller 255 communicate (such as via over-the-air signaling) may include or be associated with any combination of Wi-Fi connectivity, cellular connectivity, Bluetooth connectivity, Zigbee connectivity, wired connectivity (such as via Ethernet), or IoT protocols such as Message Queuing Telemetry Transport (MQTT), Matter, ioFog, or other protocols. Client devices 205, host devices 210, and the distributed computing controller 255 may interface with network connectivity components via one or multiple interfaces. For example, a client device 205 and a host device 210 may support a distributed computing API 265 and a distributed computing API 275, respectively, and an original equipment manufacturer (OEM) API 270 and an OEM API 280, respectively. The distributed computing controller 255 may support a distributed computing API 285 and, in some examples, may support a distributed computing API 290 to interface with a cloud edge 260.

In some examples, the host devices 210 (which may be equivalently referred to herein as edge devices or edge nodes) may not be dedicated for running workloads 240 (such as computing workloads) assigned by the distributed computing controller 255 or another workload scheduler device. In other words, the host devices 210 may launch and run native applications 235 separate from, such as in addition to, any workloads 240 assigned to the host devices by the workload scheduler device (such as the distributed computing controller 255). For example, the host devices 210 may be end user devices with on-device user applications outside the control of the workload scheduler device. In some aspects, a host device 210 and the distributed computing controller 255 may balance how many computing resources are available for (such as reserved for or used by) native (such as local or on-device) applications with how many computing resources are available for (such as reserved for or used by) assigned edge workloads 240. Further, the host devices 210 (and the client devices 205) may be on-premises devices with heterogeneous capabilities that may join or leave the cluster (such as the local edge cluster) or change connectivity within the cluster dynamically.

Thus, in accordance with some of the example implementations disclosed herein, the workload scheduler device may consider (such as account for, factor in, or evaluate) one or more computation metrics, one or more communication metrics, one or more power supply metrics, and one or more reliability metrics to consider the relevant criteria more fully for distributed computing ecosystems in workload scheduling. For example, even though a first host device 210 may have relatively greater computation capabilities or resources as compared to a second host device 210, the workload scheduler device may assign a workload to the second host device 210 if relatively greater communication metric(s), power supply metric(s), or reliability metric(s) of the second host device 210 sufficiently outweigh any shortcoming of the second host device 210 in terms of computation capabilities or resources. In such examples, the workload scheduler device may perform a first joint evaluation for the first host device 210 (of a first set of one or more computation metrics, communication metrics, power supply metrics, and reliability metrics associated with the first host device 210) and a second joint evaluation for the second host device 210 (of a second set of one or more computation metrics, communication metrics, power supply metrics, and reliability metrics associated with the second host device 210) and may assign the workload to the second host device 210 in accordance with the second joint evaluation providing (such as resulting in) a greater score than the first joint evaluation.

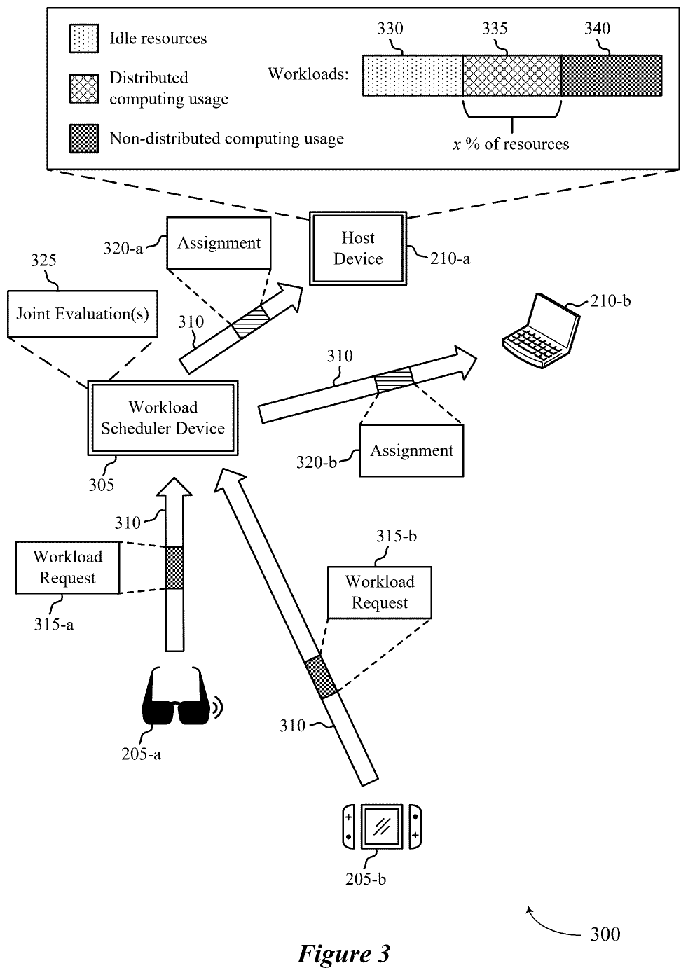

FIG. 3 shows an example signaling diagram 300 that supports workload scheduling in edge computing. The signaling diagram 300 may implement or be implemented to realize one or more aspects of the connected edge cluster architecture 200. For example, the signaling diagram 300 illustrates communication between a client device 205-a, a client device 205-b, a host device 210-a, a host device 210-b, and a workload scheduler device 305. The client device 205-a and the client device 205-b may be examples of client devices 205 as illustrated by and described with reference to FIG. 2. The host device 210-a and the host device 210-b may be examples of host devices 210 as illustrated by and described with reference to FIG. 2. Further, although illustrated and described in examples as “host” devices and “client” devices, the various devices illustrated by and described with reference to FIG. 3 may serve, operate, or function as either a host device or a client device on a per workload basis. The workload scheduler device 305 may be an example of a distributed computing controller 255 as illustrated by and described with reference to FIG. 2. The client device 205-a, the client device 205-b, the host device 210-a, the host device 210-b, and the workload scheduler device 305 may communicate with each other via communication links 310, which may be examples of over-the-air communication links (such as cellular, Bluetooth, or Wi-Fi links), wired communication links (such as Ethernet links), or any combination thereof. The communication links 310 may be associated with the network connectivity 250 as illustrated by and described with reference to FIG. 2.

In some implementations, the client device 205-a and the client device 205-b may launch respective applications and, in accordance with launching the respective applications, may have respective workloads for processing. Additionally, or alternatively, the client device 205-a and the client device 205-b identify, select, determine, ascertain, or otherwise obtain respective workloads for processing in accordance with ongoing applications at the client device 205-a and the client device 205-b. In either or both of such scenarios, the client device 205-a may have a first workload for processing and the client device 205-b may have a second workload for processing.

In examples in which the client device 205-a and the client device 205-b are unequipped or lack the processing or computational capabilities or resources to process the first workload and the second workload, respectively (or otherwise determine or estimate that workload processing may be more efficiently or accurately performed by a different device), the client device 205-a and the client device 205-b may request assignment of the first and second workloads to one or more host devices 210. In other words, the client device 205-a and the client device 205-b may request that host device(s) 210, which may have relatively greater processing or computational capabilities or resources as compared to the client device 205-a and the client device 205-b, process the first and second workloads and return information associated with the workloads (such as results of the workloads) to the client device 205-a and the client device 205-b after processing. For example, the client device 205-a may transmit a workload request 315-a associated with the first workload and the client device 205-b may transmit a workload request 315-b associated with the second workload.

In some aspects, the client device 205-a, via the workload request 315-a, may provide information indicative of a first set of one or more parameters associated with the first workload. The client device 205-b, via the workload request 315-b, may provide information indicative of a second set of one or more parameters associated with the second workload. Such parameters associated with a requested workload may include one or more of a workload type, an indication of an affinity of the requested workload, a requested completion time, a requested power source or battery power metric, a requested software or hardware capability, one or more weightings associated with a joint evaluation of a host device 210 for workload assignment, a requested service level agreement (SLA), or any combination thereof. The workload request 315-a or the workload request 315-b may be conveyed via a single message or packet or via multiple messages or packets.

A workload type may indicate that a requested workload is “session-oriented” or “one-shot.” A session-oriented workload type may indicate that a workload host is expected to keep (such as establish and maintain) a data session with a peer device (such as the requesting client device 205 or another device). For example, a session-oriented workload type may be associated with continuous, periodic, frequent, or ongoing processing tasks that are associated with data transmissions from the peer device. A one-shot workload type may indicate that one or more tasks associated with the workload run to completion on their own and that the input data is provided in the workload request (such as in the workload request 315-a or workload request 315-b). For example, a one-shot workload type may be completed without establishing a data session with a peer device.

An indication of an affinity of the requested workload may include information indicative of a compatibility or similarity between the requested workload and another workload or between the requested workload and a potential host device 210. A requested completion time may be an indication of a time within which the requesting client device 205 expects a result associated with the requested workload. A requested power source or battery power metric may indicate a request for a host device 210 connected to an electrical grid (such as a “plugged-in” device) or may indicate a threshold battery power level (such that an assigned host device 210 may be expected to have a battery power level that satisfies the threshold battery power level, if the host device 210 is not connected to the electrical grid).

A requested software or hardware capability may indicate a target operating system (OS), a target software or hardware architecture, a container flag, a quantity of central processing unit (CPU) cores, a quantity of graphics processing unit (GPU) cores, a storage availability, or a memory availability, among other examples of software or hardware that a client device 205 may request. One or more weightings may include weightings that the client device 205 requests the workload scheduler device 305 to use as part of a joint evaluation performed for workload assignment, such as in examples in which the workload scheduler device 305 uses the joint evaluation to obtain a weighted sum.

A requested SLA may indicate one or more criteria or metrics that the requesting client device 205 expects to be satisfied by the host device 210 assigned for workload processing, such as a quality of service (QOS). The QoS may be associated with a slice type, such as enhanced mobile broadband (eMBB), ultra-reliable low latency communication (URLLC), or massive machine type communication (mMTC). Additionally, or alternatively, a requested SLA may be workload type dependent. For example, for a session-oriented workload type, a requested SLA may indicate a first set of one or more metrics and, for a one-shot workload type, a requested SLA may indicate a second set of one or more metrics. Such a first set of one or more metrics may include one or more of a node ID for a session peer per direction (such as for peer-to-host communication and for host-to-peer communication), a target or expected throughput, or a target or expected latency. Such a second set of metrics may include an indication of a target or expected completion time.

The workload scheduler device 305, which may be an edge node (such as an edge node with connectivity to a cloud edge, such as the cloud edge 260 as illustrated by and described with reference to FIG. 2), may receive the workload request 315-a and the workload request 315-b from the client device 205-a and the client device 205-b, respectively. In accordance with receiving the workload request 315-a and the workload request 315-b, the workload scheduler device 305 may assign the first and second workloads to one or more host devices 210. For example, and as illustrated by FIG. 3, the workload scheduler device 305 may transmit an indication of an assignment 320-a of the first workload to the host device 210-a and may transmit an indication of an assignment 320-b of the second workload to the host device 210-b.

In some implementations, the workload scheduler device 305 may perform one or more joint evaluations 325 to determine or select (and transmit indications of) the assignment 320-a to the host device 210-a and the assignment 320-b to the host device 210-b. For example, the workload scheduler device 305 may perform a first set of joint evaluations 325 associated with (such as for) the first workload and may perform a second set of joint evaluations associated with (such as for) the second workload. The workload scheduler device 305 may perform the first set of joint evaluation 325 in accordance with performing a respective joint evaluation, for each host device 210 of a set of host devices 210 and in accordance with the first set of one or more parameters associated with the first workload, of one or more computation metrics, one or more communication metrics, one or more power supply metrics, and one or more reliability metrics. Further, the workload scheduler device 305 may perform the second set of joint evaluation 325 in accordance with performing a respective joint evaluation, for each host device 210 of a set of host devices 210 and in accordance with the second set of one or more parameters associated with the second workload, of one or more computation metrics, one or more communication metrics, one or more power supply metrics, and one or more reliability metrics.

For example, the first set of joint evaluations 325 may include a first joint evaluation 325 of the host device 210-a for the first workload and a second joint evaluation 325 of the host device 210-b for the first workload. In such examples, the first joint evaluation 325 of the host device 210-a may consider (such as account for or factor in) a first set of one or more computation metrics associated with the host device 210-a, a first set of one or more communication metrics associated with the host device 210-a, a first set of one or more power supply metrics associated with the host device 210-a, and a first set of one or more reliability metrics associated with the host device 210-a. The second joint evaluation 325 of the host device 210-b may consider (such as account for or factor in) a second set of one or more computation metrics associated with the host device 210-b, a second set of one or more communication metrics associated with the host device 210-b, a second set of one or more power supply metrics associated with the host device 210-b, and a second set of one or more reliability metrics associated with the host device 210-b. The workload scheduler device 305 may obtain a first score from the first joint evaluation 325 and a second score from the second joint evaluation 325 and may assign the first workload to the host device 210-a or the host device 210-b in accordance with which of the first score or the second score is greater. In some aspects, the workload scheduler device 305 may assign the first workload to the host device 210-a (via the assignment 320-a) in accordance with the first score being greater than the second score.

For further example, the second set of joint evaluations 325 may include a third joint evaluation 325 of the host device 210-a for the second workload and a fourth joint evaluation 325 of the host device 210-b for the second workload. In such examples, the third joint evaluation 325 of the host device 210-a may consider (such as account for or factor in) a first set of one or more computation metrics associated with the host device 210-a, a first set of one or more communication metrics associated with the host device 210-a, a first set of one or more power supply metrics associated with the host device 210-a, and a first set of one or more reliability metrics associated with the host device 210-a. The fourth joint evaluation 325 of the host device 210-b may consider (such as account for or factor in) a second set of one or more computation metrics associated with the host device 210-b, a second set of one or more communication metrics associated with the host device 210-b, a second set of one or more power supply metrics associated with the host device 210-b, and a second set of one or more reliability metrics associated with the host device 210-b. The workload scheduler device 305 may obtain a third score from the third joint evaluation 325 and a fourth score from the fourth joint evaluation 325 and may assign the second workload to the host device 210-a or the host device 210-b in accordance with which of the third score or the fourth score is greater. In some aspects, the workload scheduler device 305 may assign the second workload to the host device 210-b (via the assignment 320-b) in accordance with the fourth score being greater than the third score.

In some implementations, the workload scheduler device 305 may continuously track (such as receive indications of or otherwise monitor) resource availability or usage on host devices 210 and may incorporate resource availability or usage into the joint evaluations 325. For example, the workload scheduler device 305 may set (such as select, determine, identify, calculate, or otherwise ascertain) a maximum (such as upper limit) cap on distributed computing usage 335 for each host device 210 to avoid adversely impacting native application performance. In other words, because the host devices 210 may be absent of (such as lack) dedicated resources for distributed computing applications, the workload scheduler device 305 may assign workloads to host devices 210 in view of a possibility that a host device 210 launches a native application while processing an assigned distributed computing workload. In some deployment scenarios or for some types of host devices 210, non-distributed computing usage 340 may be highly dynamic depending on user interaction (such as a launching of a native application, such as a launching of a video game on a laptop).

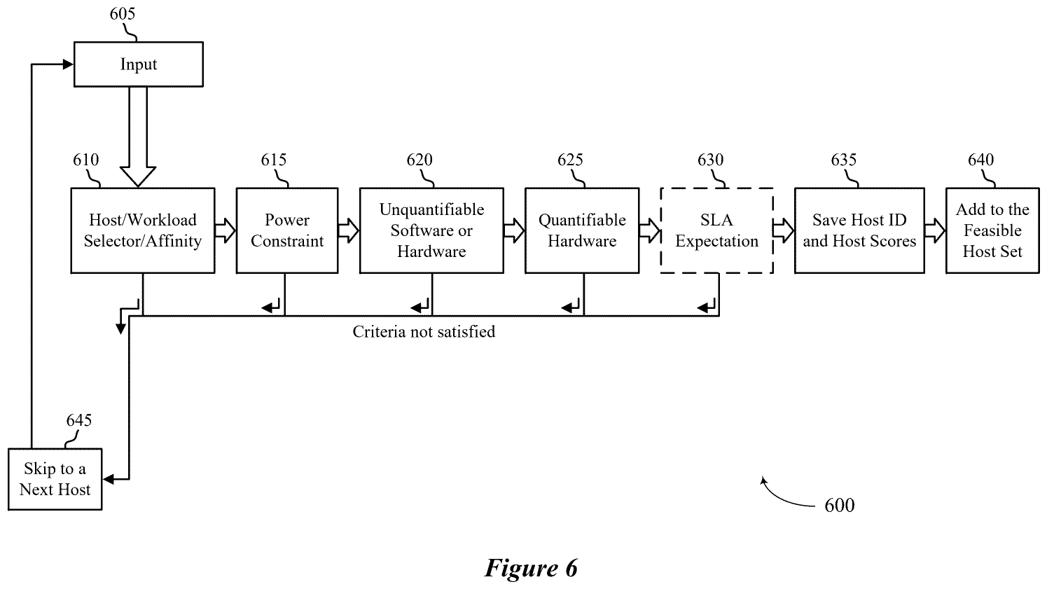

In some aspects, the workload scheduler device 305 may set the limit (such as a cap) on distributed computing usage 335 such that distributed computing usage 335 is less than or equal to a threshold percentage (or ratio) of resources (such as integrated hardware resources, such as computational, memory, or storage resources) of the host device 210. Such a threshold percentage may be set to x %, where x may be any quantity including 10, 15, 20, 25, 30, and so on. Additionally, or alternatively, the workload scheduler device 305 may set a limit on distributed computing usage 335 such that distributed computing usage 335 is associated with less than or equal to a threshold quantity of resources, where such a threshold quantity of resources may refer to a quantity of processing blocks, a quantity of CPU cores, a quantity of GPU cores, an amount of memory, or the like. Further, in view of the highly dynamic nature of the non-distributed computing usage 340, the workload scheduler device 305 may set a limit on distributed computing usage 335 to provide for an amount (such as a threshold percentage or a threshold quantity) of idle resources 330. Thus, the workload scheduler device 305 may set a limit on distributed computing usage 335 such that distributed computing usage 335 is less than or equal to a threshold percentage or quantity, such that non-distributed computing usage 340 is at least a threshold percentage or quantity, such that idle resources are at least a threshold percentage or quantity, or any combination thereof. If, for example, computation, memory, or storage usage for distributed computing workloads exceeds a fixed percentage or quantity at a host device 210, or if a power of the host device 210 falls below a fixed (or self-defined) percentage or ratio, a status of the host device 210 may be set to busy and the workload scheduler device 305 may skip the host device 210 for workload assignments. In some implementations, the workload scheduler device 305 may skip the host device 210 during host a filtering procedure, as illustrated by and described in more detail with reference to FIGS. 5 and 6.

The workload scheduler device 305 may set a respective maximum cap on distributed computing usage 335 on each host device 210 in accordance with usage history of that host device 210. In some implementations, the workload scheduler device 305 may set a same maximum cap on distributed computing usage 335 for each host device 210 of a set of host devices 210. In some other implementations, the workload scheduler device 305 may set different (or at least separately defined or indicated) maximum caps on distributed computing usage 335 for each host device 210 of a set of host devices 210. The workload scheduler device 305 may account for such resource availability or usage (in view of the caps on distributed computing usage 335) as a computation or reliability metric or may account for such resource availability or usage as a separate metric (such as a standalone metric separate from, and in addition to, computation and reliability metrics).

Additionally, or alternatively, the workload scheduler device 305 may monitor for link utilization or packet loss reports. For example, APs or other network entities 105 may transmit (such as report), to the workload scheduler device 305, information indicative of a link utilization or information indicative of a packet loss (such as retransmission), or both. In such examples, the workload scheduler device 305 may use such reported information to determine, identify, or ascertain one or more congested areas of a network (such as some hotspots of signaling congestion). The workload scheduler device 305 may determine, identify, or ascertain one or more congested areas in accordance with one or more metrics associated with a quantity of channel accesses, a percentage of available spectrum used, a quantity of collisions, a quantity of retransmissions, a quantity of scheduling requests, a quantity of connection (such as random access) attempts, or any combination thereof.

Additionally, or alternatively, the workload scheduler device 305 may monitor whether the parameters, targets, requests, or expectations of assigned workloads are satisfied. In other words, the workload scheduler device 305 may monitor workload execution at one or more host devices 210. For example, the workload scheduler device 305 may receive, from client devices 205 or host devices 210, information indicative of whether one or more parameters associated with assigned workloads are consistently satisfied (such as satisfied at least a threshold percentage of the time, or such that a threshold quantity or percentage of the parameters are satisfied). If the workload scheduler device 305 receives information indicating that one or more parameters associated with assigned workloads are not consistently satisfied, the workload scheduler device 305 may reschedule one or more workloads, reassign one or more workloads, or reconfigure a topology of the network.

Further, if the workload scheduler device 305 (re)deploys a sequence of workloads or receives information indicating that the sequence of workloads are being (re)deployed (such as at the workload scheduler device 305, at a given host device 210, or across a set of multiple host devices 210), the workload scheduler device 305 may calculate (or receive information indicative of) a weighted sum of the queuing times associated with the sequence of workloads. Such a weighted sum may be weighted in accordance with (such as based on) using workload priorities as weightings. For example, a first workload associated with a first queuing time and a first priority value may be given a weighted queuing time associated with (such as equal to) a first product of the first queuing time and the first priority value. For further example, a second workload associated with a second queuing time and a second priority value may be given a weighted queuing time associated with (such as equal to) a second product of the second queuing time and the second priority value. In such examples, a weighted sum of the queuing times may include a summation of the first product and the second product. A relatively large (weighted sum) queuing time (such as larger than or equal to a threshold time) may indicate a cluster status is busy. Likewise, a relatively small (weighted sum) queuing time (such as smaller than or equal to a threshold time) may indicate that a cluster status is idle or available.

In some implementations, the workload scheduler device 305 may monitor a distribution of workloads across a set of host devices 210 and may assign workloads to balance the distribution of the workloads across the set of host devices 210. For example, the workload scheduler device 305 may assign workloads to the host device 210-a and the host device 210-b such that a first set of workloads assigned to the host device 210-a is approximately commensurate to a second set of workloads assigned to the host device 210-b. The first set of workloads may be approximately commensurate to the second set of workloads in accordance with the first set of workloads and the second set of workloads being associated with approximately equal quantities or percentages (measured on a per-device basis) of computation resources, approximately equal priorities, or any combination thereof.

Additionally, or alternatively, the workload scheduler device 305 may monitor a reliability of one or more host devices 210 in accordance with monitoring a rescheduling or a preemption rate at the one or more host devices 210. For example, the workload scheduler device 305 may use a percentage of rescheduling or preemption to characterize a reliability of a cluster. A host device 210 may reschedule or preempt an assigned distributed computing workload in accordance with a network change, an exit of the host device 210 from the cluster, a local application launch, or a higher-priority edge compute workload launch.

The workload scheduler device 305 may perform one or more workload updates in accordance with distributed computing cluster monitoring (such as status monitoring of distributed computing clusters, such as in accordance with monitoring percentage usage of resources at host devices 210, link utilization or packet loss reports, workload execution, workload distribution, or rescheduling/preemption). In some aspects, in accordance with host mobility, network condition(s), local applications, or higher-priority edge compute workloads at a host device 210, the workload scheduler device 305 may redeploy an assigned workload or adjust, reconfigure, or otherwise update a network or cluster topology. Additionally, or alternatively, if the workload scheduler device 305 receives information indicating that one or more workloads are past a completion deadline, the workload scheduler device 305 may send the workload (or an indication of the workload, potentially along with an indication of a rejection or decline of the workload) back to the client device 205. In some examples, the workload scheduler device 305 or a host device 210 may sort (such as order or organize) workloads in accordance with a respective priority or a respective completion deadline associated with each of the workloads. In some examples, the workload scheduler device 305 may (re)assign workloads or (re)configure a workload deployment to balance a workload distribution across a set of host devices 210 (or in accordance with receiving information indicating that a workload distribution is imbalanced). Further, in some aspects, the workload scheduler device 305 may limit a quantity of workloads in a queue. For example, the workload scheduler device 305 may set (such as configure) a maximum or upper limit quantity of N workloads allowed in a queue of the workload scheduler device 305.

Further, in terms of distributed computing usage 335 at a host device 210 (such as the host device 210-a), the workload scheduler device 305 or the host device 210 may perform one or more operations in accordance with whether one or more threshold percentages are satisfied. For example, if the distributed computing usage 335 at the host device 210-a satisfies (such as exceeds) a first threshold percentage x₁, the workload scheduler device 305 may skip the host device 210-a in a filtering step. Additionally, or alternatively, if the distributed computing usage 335 at the host device 210-a satisfies (such as exceeds) a second threshold percentage x₂, the host device 210-a may preempt one or more workloads assigned to the host device 210-a (in favor of allocating sufficient resources for one or more native applications of the host device 210-a). Additionally, or alternatively, if the distributed computing usage 335 at the host device 210-a satisfies (such as exceeds) a third threshold percentage x₃, the host device 210-a may reject new incoming workloads. For example, the host device 210-a may transmit an indication of a rejection to the workload scheduler device 305 in association with receiving an assignment of a workload from the workload scheduler device 305 when the distributed computing usage 335 at the host device 210-a satisfies (such as exceeds) the third threshold percentage x₃.

In accordance with monitoring link utilization, packet loss reports, or rescheduling/preemption occurrences, the workload scheduler device 305 may selectively prohibit or reject workload requests. For example, if the network becomes congested (such as in accordance with or otherwise indicated by a relatively high packet loss, retransmission, or link utilization), the workload scheduler device 305 may stop (all or relatively lower priority) incoming session-oriented workloads (such as session-oriented jobs). In such examples, the workload scheduler device 305 may transmit an indication of a rejection of (such as a prohibition against) workloads associated with a session-oriented workload type. Additionally, or alternatively, if a rescheduling/preemption rate is relatively high (such as greater than or equal to a threshold rate), the workload scheduler device 305 may reject new incoming workload requests until the distributed computing cluster is stable again. In such examples, the workload scheduler device 305 may transmit an indication of a rejection of (such as a prohibition against) workloads associated any workload type.

In some implementations, the workload scheduler device 305 may support a compute aware network resource allocation. In such implementations, the workload scheduler device 305, or one or more host devices 210 or other edge nodes, may offload links on highly utilized channels to other channels. For example, the workload scheduler device 305, or another edge node, may change a connection between two network devices (such as APs or any other network entities 105) from a first channel (such as a 2.4 GHz channel) to a second channel (such as a 5 GHz channel). Additionally, or alternatively, the workload scheduler device 305 may configure a trajectory for workloads in accordance with a network resource allocation. For example, the workload scheduler device 305 may change a route of one or more session-oriented workloads to one or more links with relatively less traffic. Additionally, or alternatively, the workload scheduler device 305 may limit the quantity of incoming session-oriented workloads (such as to an upper limit threshold quantity) in distributed computing clusters to avoid causing network congestion.

Additionally, or alternatively, the workload scheduler device 305 may steer a host device 210 to a specific network device (such as a specific AP, gNB, router, or other network entity 105) if there are distributed computing applications running on the specific network device. In other words, the workload scheduler device 305 may connect the host device 210 with a network device having a better connection for the host device 210 (such as a distributed computing host), such as a connection that is relatively better for a particular workload. In such examples, the workload scheduler device 305 may transmit, to the host device 210, a first network device, or a second network device, information indicative of a handover of the host device 210 to the first network device from the second network device. In some aspects, the host device 210 may have a wired connection (such as an Ethernet connection) with one or both of the first network device or the second network device. In such aspects, the workload scheduler device 305 may steer the host device 210 to a wired connection from a wireless connection, to a wireless connection from a wired connection, to a first wired connection from a second wired connection, or to a first wireless connection from a second wireless connection. Further, in some implementations, the workload scheduler device 305 may disconnect other devices connected to the first network device. Additionally, or alternatively, the first network device may change a (dedicated) channel for the host device 210 (such as the compute node). In some examples, the workload scheduler device 305 may configure network devices (functioning as or supporting host devices 210) to serve at most one or a fixed quantity of session-oriented workloads per channel. In such examples, the workload scheduler device 305 may transmit information indicative of such a fixed quantity to the network devices. Additionally, or alternatively, such a fixed quantity may be provided by a network specification.

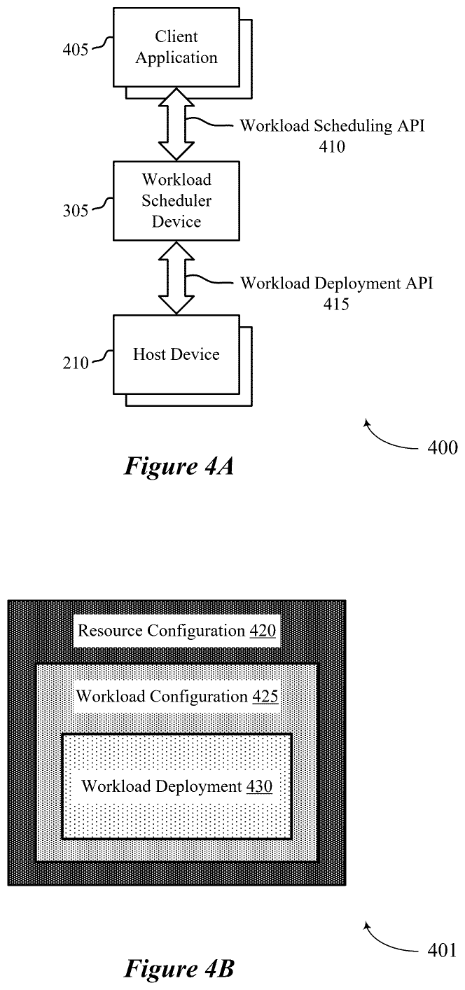

FIG. 4A shows an example workload scheduling diagram 400 that supports workload scheduling in edge computing. The workload scheduling diagram 400 may implement or be implemented to realize one or more aspects of the connected edge cluster architecture 200 or the signaling diagram 300. For example, the workload scheduling diagram 400 illustrates an interfacing between a client application 405, a workload scheduler device 305, and a host device 210. The host device 210 may be an example of a host device 210 as illustrated by and described with reference to FIGS. 2 and 3 and the workload scheduler device 305 may be an example of a workload scheduler device 305 as illustrated by and described with reference to FIG. 3. The client application 405 may run at a client device 205, such as a client device 205 as illustrated by and described with reference to FIGS. 2 and 3.

The workload scheduler device 305 may interface with the client application 405 via a workload scheduling API 410 and may interface with the host device 210 via a workload deployment API 415. Further, although illustrated as having one workload scheduling API 410 and one workload deployment API 415, the workload scheduler device 305 may have any quantity of workload scheduling APIs 410 (such as one for each client application 405 of a set of client applications 405) and any quantity of workload deployment APIs 415 (such as one for each host device 210 of a set of host devices 210). The workload scheduling API 410 may be an external workload orchestration API for distributed computing client applications. The workload deployment API 415 may be an example of an internal workload deployment API to the host devices 210 (via, for example, Device Service).

The workload scheduler device 305, in accordance with aspects of the workload scheduling diagram 400, may manage containerized and native application workloads within a distributed computing cluster, including workload scheduling (such as finding the right host device 210 for each application workload) and workload lifespan management. In some implementations, the workload scheduler device 305 (functioning as a distributed computing workload orchestrator) may orchestrate workloads between the edge and the cloud. For example, if (sufficient) resources are not available on the edge, the workload scheduler device 305 may offload some workloads to the cloud (such as the cloud edge 260 as illustrated by and described with reference to FIG. 2). Thus, and in accordance with some example implementations disclosed herein, the workload scheduler device 305 may leverage cloud capabilities while addressing edge-specific characteristics.

FIG. 4B shows an example nested workload scheduling algorithm 401 that supports workload scheduling in edge computing. The nested workload scheduling algorithm 401 may implement or be implemented to realize one or more aspects of the connected edge cluster architecture 200, the signaling diagram 300, or the workload scheduling diagram 400. For example, a workload scheduler device 305, such as a workload scheduler device 305 as illustrated by and described with reference to FIGS. 3 and 4A, may perform one or more operations associated with the nested workload scheduling algorithm 401 as part of distributed computing workload scheduling.

In accordance with the nested workload scheduling algorithm 401, the workload scheduler device 305 or another edge node may perform one or more operations association with a resource configuration 420 (such as a resource optimization), a workload configuration 425 (such as a workload optimization), and a workload deployment 430. The resource configuration 420 may include a (re) configuring, by the workload scheduler device 305 or another edge node, of a cluster resource. For example, the workload scheduler device 305 or another edge node may update a topology associated with a distributed computing cluster. The workload configuration 425 may include a (re) deploying, by the workload scheduler device 305 or another edge node, of one or more active workloads. For example, the workload scheduler device 305 or another edge node may redeploy one or more active workloads in accordance with a preemption or local/global bin packing.

The workload deployment 430 may include a selecting, by the workload scheduler device 305, of a host device 210 (such as a host device 210 as illustrated by and described with reference to FIGS. 2, 3, and 4A) to which to deploy a new workload in accordance with a client request. For example, the workload scheduler device 305 may transmit an indication of assignment of a workload to at least a host device 210 as part of the workload deployment 430. In accordance with some example implementations disclosed herein, the workload scheduler device 305 may assign a workload to a host device 210 in accordance with a respective joint evaluation, for each host device 210 of a set of host devices 210 and in accordance with one or more parameters associated with the workload or a corresponding client request, of one or more computation metrics, one or more communication metrics, one or more power supply metrics, and one or more reliability metrics.

In some examples, algorithm complexity, cluster performance, or execution cost may scale in correlation with a progression from the workload deployment 430 to the workload configuration 425 and to the resource configuration 420. Further, the nested workload scheduling algorithm 401 may be associated with a set of one or more inputs and a set of one or more outputs. The set of one or more inputs may include, for example, a cluster resource specification (such as a resource configuration or allocation), an existing workload-to-host device mapping, or a workload specification (such as one or more parameters associated with a workload). The set of one or more outputs may include, for example, an updated workload-to-host device mapping or an updated cluster resource specification.

FIG. 5 shows an example workload deployment algorithm 500 that supports workload scheduling in edge computing. The workload deployment algorithm 500, which may be an example of a distributed computing workload deployment algorithm, may implement or be implemented to realize aspects of the wireless communication system 100, the connected edge cluster architecture 200, the signaling diagram 300, the workload scheduling diagram 400, or the nested workload scheduling algorithm 401. For example, a workload scheduler device 305 may perform the operations associated with the workload deployment algorithm 500 and such a workload scheduler device 305 may be an example of a distributed computing controller 255 or a workload scheduler device 305 as illustrated by or described with reference to FIG. 2, 3, 4A, or 4B.

The workload deployment algorithm 500 may be associated with a three-step process involving a first step of looping through one or multiple workload variants while finding feasible host devices 210, a second step of finding a set of host devices 210 capable of running the workload, and a third step of ranking the feasible (such as eligible) host devices 210 to select a best host device 210 for the workload, with such a “best” host device 210 being understood as a host device 210 having a greatest score, a lowest score, or a score closest to a target score in accordance with the ranking. In some aspects, the first step may be understood as a multiple variant step, the second step may be understood as a filtering step, and the third step may be understood as a scoring step.

The workload scheduler device 305 may initiate, start, begin, or trigger the workload deployment algorithm 500 in association with receiving a workload request 505. In some examples, the workload scheduler device 305 may receive the workload request 505, which may be a request for or otherwise associated with a workload, from a client device 205. The workload request 505 may be an example of the workload request 315-a or the workload request 315-b as illustrated by and described with reference to FIG. 3. In some aspects, the workload scheduler device 305 may receive, via the workload request 505 or via separate signaling or messaging, one or more parameters associated with the workload. Such parameters associated with a requested workload may include one or more of a workload type, an indication of an affinity of the requested workload, a requested completion time, a requested power source or battery power metric, a requested software or hardware capability, one or more weightings associated with a joint evaluation of a host device 210 for workload assignment, a requested SLA, or any combination thereof.

The workload scheduler device 305, in accordance with receiving the workload request 505 and the one or more parameters associated with the workload, may obtain (such as identify, configure, calculate, or generate) a set of one or more workload variants associated with the workload and may evaluate a host device 210 to identify, calculate, determine, or ascertain whether the host device 210 is capable of processing any one or more of the various workload variants. Such various workload variants may include, for purpose of example in the illustration of FIG. 5, one or more of a workload variant 510-a, a workload variant 510-b, or a workload variant 510-c. Each workload may be associated with a specific permutation of a set of workload factors. Such workload factors may include one or more of an image URI, an architecture (such as x86, arm64, RISC-V, or the like), an operating system (such as Linux, Windows, Android, or the like), a container flag (such as “true” or “false”), or resource expectations or requirements (such as for storage, memory, CPU capability (in units of, for example, millicpu), or GPU capability). In some aspects, the workload scheduler device 305, the client device 205, or the host device 210 may support different variants of workloads to fit into (such as to be compatible with) different device platforms and capabilities.

The workload scheduler device 305 may perform a filtering 515 to identify, determine, or ascertain whether a host device 210 is capable of processing at least one of the various workload variants. For example, if a host device 210 is capable of processing at least one of the various workload variants, the workload scheduler device 305 may add the host device 210 to a feasible host set (such as a set of host devices 210). If the host device 210 is not capable of processing at least one of the various workload variants, the workload scheduler device 305 may exclude the host device 210 from the feasible host set. The workload scheduler device 305 may perform the filtering 515 across all potential host devices 210 (in view of at least one of the various workload variants) to obtain the feasible host set, which may include one or multiple host devices 210. In some aspects, the workload scheduler device 305 may start by performing the filtering 515 using a first (such as highest priority) workload variant and, if no host devices 210 are capable of processing the first workload variant, may subsequently perform the filtering 515 using a second (such as next highest priority) workload variant, and so on until the workload scheduler device 305 finds a workload variant supported by at least one host device 210. Additional details relating to the filtering 515 are illustrated by and described with reference to FIG. 6.

For example, in accordance with the filtering 515 to obtain the feasible host set, the workload scheduler device 305 may perform a decision 520 to identify, determine, or ascertain whether the feasible host set is empty. An empty feasible host set may indicate that the feasible host set includes zero host devices 210. If the feasible host set is empty, meaning that all potential host devices 210 were filtered out by the filtering 515, the workload scheduler device 305 may perform a decision 525 to identify, determine, or ascertain whether a most recently evaluated workload variant is a last workload variant (of a set of generated workload variants). If not, the workload scheduler device 305 may evaluate a next workload variant to identify, determine, or ascertain whether one or more host devices 210 are capable of processing the next workload variant. If yes, the workload scheduler device 305 may perform a workload configuration 530. The workload configuration 530, which may be alternatively referred to as a workload optimization, may be an example of the workload configuration 425 as illustrated by and described with reference to FIG. 4B. The workload configuration 530 (and, likewise, the workload configuration 425) may be understood as an outer loop or a second phase of a nested workload scheduling algorithm, such as the nested workload scheduling algorithm 401 as illustrated by and described with reference to FIG. 4B.

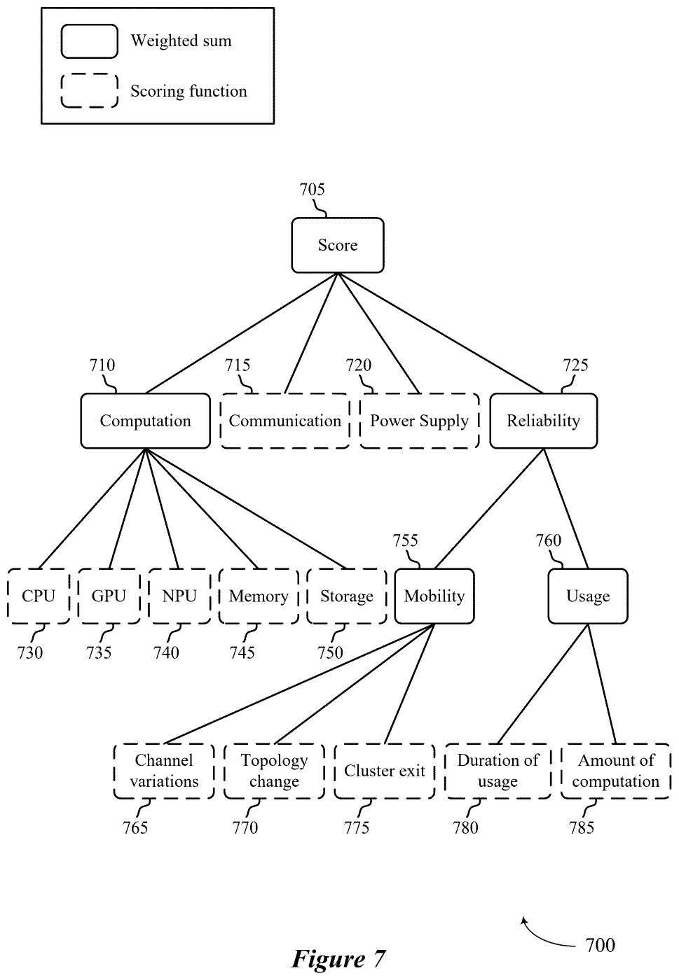

Alternatively, if the workload scheduler device 305 identify, determines, or ascertains that the feasible host set is not empty at the decision 520, the workload scheduler device 305 may perform a scoring 535 for each host device 210 within the feasible host set. In accordance with the scoring 535, the workload scheduler device 305 may obtain (such as calculate, determine, select, or ascertain) a score or rank for each host device 210 within the feasible host set. For example, if the feasible host set includes a first host device 210 and a second host device 210, the workload scheduler device 305 may obtain, via the scoring 535, a first score or rank for the first host device 210 and a second score or rank for the second host device 210. Additional details relating to the scoring 535 are illustrated by and described with reference to FIG. 7.

In accordance with the scoring 535, the workload scheduler device 305 may perform a workload assignment 540 to deploy the workload on a selected host device 210. For example, the workload scheduler device 305 may select a host device 210, from the set of host devices 210 within the feasible host set, on which to deploy the requested workload in accordance with the scores or ranks obtained via the scoring 535. In the example in which the workload scheduler device 305 obtains the first score or rank for the first host device 210 and the second score or rank for the second host device 210, the workload scheduler device 305 may assign the workload to the first host device 210 or the second host device 210 in accordance with which of the first host device 210 or the second host device 210 has the higher score or rank, the lower score or rank, or the score or rank closer to a target score or rank. For example, in some implementations, if the first score or rank is greater than the second score or rank, the workload scheduler device 305 may assign the workload to the first host device 210. In some other implementations, if the first score or rank is less than the second score or rank, the workload scheduler device 305 may assign the workload to the first host device 210.

FIG. 6 shows an example filtering procedure 600 that supports workload scheduling in edge computing. The filtering procedure 600 may be an example of the filtering 515 as illustrated by and described with reference to FIG. 5. For example, a workload scheduler device 305 may perform the filtering procedure 600 as part of a workload deployment algorithm, such as the workload deployment algorithm 500 as illustrated and described with reference to FIG. 5. In some implementations, the workload scheduler device 305 may perform a series or sequence of steps in accordance with (as part of) the filtering procedure 600 to identify, calculate, determine, or ascertain whether a given workload variant is supported by a given host device 210 (in accordance with a capability of the host device 210). For example, in accordance with the filtering procedure 600, the workload scheduler device 305 may search over all (or at least a set of) host devices 210 within a distributed computing cluster, add a constraint of power to rule out low power devices, and calculate a score for individual resources when filtering.

At 605, the workload scheduler device 305 may receive an input. The input may be associated with a given workload variant and a capability of a given host device 210. For example, the input may be associated with or otherwise indicate a node data structure (which may be indicative of the capability of the host device 210) and a workload data structure (which may be indicative of the workload variant).

At 610, the workload scheduler device 305 may perform a filtering in accordance with an affinity or selector associated with the workload. If a given host device 210 satisfies a criteria associated with the affinity or selector, the workload scheduler device 305 may pass the host device 210 to a next step of the filtering procedure 600. Such an affinity or selector associated with the workload may be understood as a host/workload selector/affinity, which may include or refer to any one or more of a host selector, a workload selector, a workload affinity, or a workload anti-affinity. The host selector (according to which a workload selects a host device 210) and the workload selector (according to which a host device 210 selects a workload) may be associated with a workload/host dependency (such as a workload/node dependency). The workload affinity and the workload anti-affinity may be associated with a workload/workload dependency.

In accordance with a host selector, a device (such as a client device 205 or the workload scheduler device 305) may assign tags to workloads and the workload scheduler device 305 may select host devices 210 (for potential inclusion in the feasible host set) with a matching tag. Such a matching between a tag of a host device 210 and a workload may provide or support a customization of additional constraints in host filtering. For example, in accordance with the host selector, a workload may only select host devices 210 with a dedicated channel connection, host devices 210 that are stationary, or the like.

In accordance with a workload selector, the workload scheduler device 305 may reserve host devices 210 for workloads with matching tags. For example, the workload scheduler device 305 may reserve a host device 210 with an Ethernet connection (such as with an Ethernet connection to a serving network device) for session-oriented or mission-critical workloads (such as for only session-oriented or mission-critical workloads). Thus, a host device 210 may be understood as selecting a workload in accordance with such a reservation of host devices 210 for workloads with a tag matching a tag of the host device 210.

In accordance with a workload affinity, the workload scheduler device 305 may deploy workloads with same tags on a same host device 210. For example, if two or more workloads are associated with a same tag, the workload scheduler device 305 may assign the two or more workloads to a same host device 210 for processing and workload execution. In such examples, the workload scheduler device 305 may reduce communication costs (if, for example, a single host device 210 may provide spectral efficiency or throughput gains by processing workloads associated with a same tag). For further example, the workload scheduler device 305 may attempt to collocate (such as assign to a single host device 210) distributed AI workloads (to reduce a communication delay). If the workload scheduler device 305 is unable to collocate distributed AI workloads at a same host device 210, the workload scheduler device 305 may assign the distributed AI workloads to two or more host devices 210 with a relatively low communication delay among the two or more host devices 210 (such that, for example, the assigned host devices 210 are relatively near each other or otherwise have communication delays between each other that satisfies a threshold communication delay).

In accordance with a workload anti-affinity, the workload scheduler device 305 may attempt to spread out some workloads across different host devices 210. For example, the workload scheduler device 305 may attempt to distribute session-oriented workloads on different host devices 210. In such examples, the workload scheduler device 305 may reduce a communication load of each assigned host device 210 and avoid a scenario in which all (or many, such as several) session-oriented workloads are rescheduled by an assigned host device 210. Such a rescheduling may occur in examples in which the assigned host device 210 moves (such as exits the distributed computing cluster), launches a relatively higher-priority native application, is subsequently assigned a relatively higher-priority edge compute workload, or suffers an adverse change in link conditions.

At 615, if a host device 210 satisfies the criteria associated with the affinity or selector, the workload scheduler device 305 may perform a filtering in accordance with a power constraint associated with the workload. If the host device 210 satisfies a criteria associated with the power constraint, the workload scheduler device 305 may pass the host device 210 to a next step of the filtering procedure 600. In some examples, the criteria associated with the power constraint may indicate an expectation or constraint for a host device 210 to be grid powered. In such examples, the power constraint criteria may indicate a threshold value s_{threshold} applicable to when the host device 210 is connected to a power grid. The host device 210 may satisfy the s_{threshold} if s≥s_{threshold}, with s being defined by Equation 1, shown below, and with P being equal to an amount of power provided by the power grid (such as 100,000 Wh). In some aspects, s of Equation 1 may be understood as a score for the host device 210 in terms of power availability.

$$s = {log}_{10} P \qquad ( 1 )$$

Additionally, or alternatively, the criteria associated with the power constraint may indicate an expectation or constraint for a host device 210 to have at least a threshold percentage of remaining battery power or at least a threshold amount of remaining battery power. For example, the criteria may include an indication of a threshold percentage of remaining battery power, such as x₁%, or an indication of a threshold amount of remaining battery power, such as x₂ watt hours (Wh).

At 620, if a host device 210 satisfies the criteria associated with the power constraint, the workload scheduler device 305 may perform a filtering in accordance with a criteria associated with unquantifiable software or hardware associated with the workload. If the host device 210 satisfies the unquantifiable software or hardware criteria, the workload scheduler device 305 may pass the host device 210 to a next step of the filtering procedure 600. In some examples, the unquantifiable software or hardware criteria may be associated with or indicate a target OS, a container flag, or a target architecture.

At 625, if a host device 210 satisfies the unquantifiable software or hardware criteria, the workload scheduler device 305 may perform a filtering in accordance with a criteria associated with quantifiable hardware associated with the workload. If the host device 210 satisfies the quantifiable hardware criteria, the workload scheduler device 305 may pass the host device 210 to a next step of the filtering procedure 600. In some examples, the quantifiable hardware criteria may be associated with or indicate an expectation or target amount of computation resources. Such computation resources may include an amount of storage (such as an amount of available storage), an amount of memory (such as an amount of available memory), a quantity of (available) CPU cores, a quantity of (available) GPU cores, or a quantity of (available) NPUs at the host device 210. If the host device 210 has at least the expected or target amount of computation resources, the host device 210 may pass the filtering at 625.

In some examples, a quantifiable hardware criteria may include an indication of one or more s_{threshold} values, each of the one or more s_{threshold} values corresponding to a different threshold (such as lower limit) amount of computation resources. For example, a first s_{threshold,1} value may correspond to a percentage amount of available storage, a second s_{threshold,2} value may correspond to a percentage amount of CPU cores, and so on. In some aspects, each s_{threshold} value may correspond to a lower limit amount of resources left after considering already used resources r_{used} (if applicable) and resources expected to be used to process the workload r, with respect to a total quantity of resources rₜₒₜₐₗ at the host device 210. In such aspects, for example, the host device 210 may satisfy the s_{threshold,1} if s₁≥s_{threshold,1} and may satisfy the s_{threshold,2} if s₂≥s_{threshold,2}, with s₁ and s₂ being defined by Equations 2 and 3, respectively. Generally, the workload scheduler device 305 may use Equation 2 for memory or storage criteria and may use Equation 3 for CPU, GPU, or NPU criteria. In some aspects, s₁ and s₂ of Equations 2 and 3, respectively, may be understood as scores for the host device 210 in terms of computation or processing availability.

$${s}_{1} = 1 - \frac{r + {r}_{u s e d}}{{r}_{total}} \qquad ( 2 )$$

$${s}_{2} = 1 - \frac{r}{{r}_{total}} \qquad ( 3 )$$

At 630, if the host device 210 satisfies the quantifiable hardware criteria, the workload scheduler device 305 may perform a filtering in accordance with an SLA expectation (such as a target QoS) associated with the workload. If the host device 210 satisfies the SLA expectation, the workload scheduler device 305 may pass the host device 210 to a next step of the filtering procedure 600. In some implementations, the workload scheduler device 305 may evaluate whether the host device 210 satisfies the SLA expectation if the workload is a session-oriented workload type and may skip the SLA-based evaluation if the workload is not a session-oriented workload type. In other words, the workload scheduler device 305 may evaluate whether the host device 210 satisfies the SLA expectation only if the workload is a session-oriented workload type. In some examples, the SLA expectation may indicate one or more target throughputs or throughput margins, such as one or both of a source-to-host throughput (such as a client-to-host or scheduler-to-host throughput) or a host-to-source throughput (such as a host-to-sink or host-to-client throughput). If the host device 210 satisfies the source-to-host throughput (or throughput margin) and the host-to-source throughput (or throughput margin), the host device 210 may satisfy the SLA expectation. In some aspects, the workload scheduler device 305 may calculate a throughput margin s in accordance with Equation 4, shown below, with R_{req} being a target (such as requested) throughput and with R being an achievable or achieved throughput. In some aspects, s of equation 4 may be understood as a score for the host device 210 in terms of throughput.

$$s = \frac{R}{{R}_{r e q}} \qquad ( 4 )$$

At 635, if the host device 210 satisfies the relevant criteria (including the SLA expectation if the requested workload is a session-oriented workload type and excluding the SLA expectation if the requested workload is a one-shot workload type), the workload scheduler device 305 may save an ID associated with the host device 210 and a set of one or more scores (such as s values) associated with the host device (with such scores being associated with the relevant criteria). In some aspects, the workload scheduler device 305 may save a score for the host device 210 for a set of metrics associated with one or more of power, memory, storage, quantity of CPU cores, quantity of CPU cores, quantity of NPU cores, or throughput.

At 640, in accordance with saving the ID of the host device 210, the workload scheduler device 305 may add the host device 210 to a feasible host set. Alternatively, if any relevant criteria is not satisfied or met by the host device 210, the workload scheduler device 305 may exit the path towards adding the host device 210 to the feasible host set and, at 645, may instead skip to a next host device 210 in a set of potentially feasible host devices 210. In some implementations, the workload scheduler device 305 may repeat the filtering procedure 600 with the next host device 210, and each subsequent next host device 210 of the set of potentially feasible host devices 210, to obtain a feasible host set of one or more host devices 210.

FIG. 7 shows an example scoring hierarchy 700 that supports workload scheduling in edge computing. In some examples, a workload scheduler device 305 may leverage or otherwise use the scoring hierarchy 700 to perform the scoring 535 as illustrated by and described with reference to FIG. 5. For example, the workload scheduler device 305 may use the scoring hierarchy 700 to obtain a score 705 for each host device 210 of a set of host devices 210 within a feasible host set. The workload scheduler device 305 may rank the set of host devices 210 of the feasible host set in accordance with the obtained scores 705, select a host device 210 from the set of host devices 210 in accordance with the ranking, and assign a requested workload to the selected host device 210.

In some implementations, the workload scheduler device 305 may obtain a score 705 for a host device 210 in accordance with a joint evaluation, for the host device 210 and in accordance with one or more parameters associated with the workload, of one or more computation metrics 710, one or more communication metrics 715, one or more power supply metrics 720, and one or more reliability metrics 725. The one or more computation metrics 710 may include one or more CPU metrics 730, one or more GPU metrics 735, one or more NPU metrics 740, one or more memory metrics 745, or one or more storage metrics 750. The one or more communication metrics 715 may include one or more connectivity metrics, one or more throughput metrics, one or more latency metrics, or one or more link condition metrics. The one or more power supply metrics 720 may include one or more power source metrics or one or more battery power metrics.

In some aspects, a computation metric 710, a communication metric 715, and a power supply metric 720 may inform or be associated with a host performance. For example, a computation metric 710 may account for preferences for host devices 210 with relatively more idle (such as available) compute resources (such as CPU, memory, storage, and the like), a communication metric 715 may account for preferences for host devices 210 with stable and relatively high end-to-end throughput, and a power supply metric 720 may account for preferences for host devices 210 with sufficient power supplies. In some aspects, the workload scheduler device 305 may consider a communication metric 715 for session-oriented workload types and may ignore a communication metric 715 for other workload types.

The one or more reliability metrics 725 may include one or more preemption metrics, one or more mobility metrics 755, or one or more usage metrics 760. The one or more mobility metrics 755 may include one or more channel variation metrics 765, one or more topology change metrics 770, or one or more cluster exit metrics 775. The one or more usage metrics 760 may include one or more duration of usage metrics 780 associated with one or more local (such as native) applications, one or more computation resource usage metrics 785 associated with the one or more local applications, an indication of one or more existing edge compute workloads, or one or more percentage metrics associated with an amount of resources used for the one or more existing edge compute workloads.

In some aspects, a host reliability metric 725 may inform or be associated with a host reliability. For example, the workload scheduler device 305 may use the host reliability metric 725 to account for (such as to reflect) historical usage information that might predict (such as be indicative of) the usage of the host device 210, historical information that might predict (such as be indicative of) a mobility of the host device 210 (such as occurrences of the host device 210 leaving a cluster, local application preemptions, or communication no longer satisfying expectations), or to evaluate a workload deployment history on the host device 210 (such as to identify, determine, or ascertain how often rescheduling occurs at the host device 210, such as rescheduling due to local application or higher-priority edge compute workload launches). In accordance with considering the host reliability metric 725, the workload scheduler device 305 may ascertain that many host devices 210 may not be suitable to provide workload services even if the such host devices 210 have spare computation resources (such as a phone running on low battery, a laptop a user uses often, or an electric vehicle that is driven away).

In terms of usage history, the workload scheduler device 305 may evaluate one or more metrics or factors associated with how long the host device 210 is accessed each day (such as in terms of hours, such as, for example, four hours) or how much computation the host device 210 performs each day (such as in terms of CPU or memory consumption). In accordance with evaluating such metrics or factors associated with usage history, the workload scheduler device 305 may avoid deploying a workload on a heavily used host device 210 (which may reduce how many preemptions are experienced). In terms of mobility (which may be associated with or informed by the mobility metric 755), the workload scheduler device 305 may evaluate how often the host device 210 is mobile (such as how often variations in channel conditions occurs, which may relate to a variance of average channel power), how often the host device 210 exits a cluster (which may relate to a quantity or frequency of preemptions), or how long the host device 210 is outside of the cluster. Further, in terms of achieving a balanced workload deployment, the workload scheduler device 305 may attempt to avoid deploying multiple (such as all) session-oriented or mission-critical workloads on one host device 210, which may protect against scenarios in which a local application or higher-priority edge compute workload is launched at the host device 210 or in which the host device 210 is or becomes mobile.

In some aspects, the score 705 may be a weighted sum in accordance with the scoring hierarchy 700. For example, a computation metric 710 (s_{compute}) may be a weighted sum of the one or more CPU metrics 730, the one or more GPU metrics 735, the one or more NPU metrics 740, the one or more memory metrics 745, and the one or more storage metrics 750. In some aspects, a first score or value associated with the one or more CPU metrics 730 may be denoted as s_{CPU}, a second score or value associated with the one or more GPU metrics 735 may be denoted as s_{GPU}, a third score or value associated with the one or more NPU metrics 740 may be denoted as s_{NPU}, a fourth score or value associated with the one or more memory metrics 745 may be denoted as s_{memory}, and a fifth score or value associated with the one or more storage metrics 750 may be denoted as s_{storage}. In some implementations, the workload scheduler device 305 may apply a respective weighting to each of s_{CPU}, s_{GPU}, s_{NPU}, s_{memory}, and s_{storage}. In such implementations, s_{compute} may be the weighted sum of s_{CPU}, s_{GPU}, s_{NPU}, s_{memory}, and s_{storage} (where each of s_{CPU}, s_{GPU}, s_{NPU}, s_{memory}, and s_{storage} may be examples of weighed values or where weightings of w_{CPU}, w_{GPU}, w_{NPU}, w_{memory}, and w_{storage} may be applied to s_{CPU}, s_{GPU}, s_{NPU}, s_{memory}, and s_{storage}, respectively). In other words, the workload scheduler device 305 may calculate a computation metric 710 in accordance with Equation 5, shown below.

$${s}_{compute} = {s}_{CPU} + {s}_{GPU} + {s}_{NPU} + {s}_{memory} + {s}_{storage} \qquad ( 5 )$$

For further example, a mobility metric 755 (s_{mobility}) may be a weighted sum of the one or more channel variation metrics 765, the one or more topology change metrics 770, and the one or more cluster exit metrics 775. In some aspects, a first score or value associated with the one or more channel variation metrics 765 may be denoted as s_{channel variations}, a second score or value associated with the one or more topology change metrics 770 may be denoted as s_{toplogy change}, and a third score or value associated with the one or more cluster exit metrics 775 may be denoted as s_{cluster exit}. In some implementations, the workload scheduler device 305 may apply a respective weighting to each of s_{channel variations}, s_{toplogy change}, and s_{cluster exit}. In such implementations, s_{mobility} may be the weighted sum of s_{channel variations}, s_{toplogy change}, and s_{cluster exit} (where each of s_{channel variations}, s_{toplogy change}, and s_{cluster exit} may be examples of weighed values or where weightings of w_{channel variations}, w_{toplogy change}, and w_{cluster exit} may be applied to s_{channel variations}, s_{toplogy change}, and s_{cluster exit}, respectively). In other words, the workload scheduler device 305 may calculate a mobility metric 755 in accordance with Equation 6, shown below.

$${s}_{mobility} = {s}_{channel variations} + {s}_{topology change} + {s}_{cluster exit} \qquad ( 6 )$$

For further example, a usage metric 760 (s_{usage}) may be a weighted sum of the one or more duration of usage metrics 780 and the one or more computation resource usage metrics 785 (potentially among other metrics). In some aspects, a first score or value associated with the one or more duration of usage metrics 780 may be denoted as s_{duration of usage} and a second score or value associated with the one or more computation resource usage metrics 785 may be denoted as s_{amount of computation}. In some implementations, the workload scheduler device 305 may apply a respective weighting to each of s_{duration of usage} and s_{amount of computation}. In such implementations, s_{usage} may be the weighted sum of s_{duration of usage} and s_{amount of computation} (where each of s_{duration of usage} and s_{amount of computation} may be examples of weighed values or where weightings of w_{duration of usage} and w_{amount of computation} may be applied to s_{duration of usage} and s_{amount of computation}, respectively). In other words, the workload scheduler device 305 may calculate a usage metric 760 in accordance with Equation 7, shown below.

$${s}_{usage} = {s}_{duration of usage} + {s}_{amount of computation} \qquad ( 7 )$$

In other words, and more generally, the workload scheduler device 305 may calculate the scores of each of the leaf nodes (illustrated in FIG. 7 with dashed-line boxes) of the scoring hierarchy 700 in accordance with scoring functions and may calculate the scores in the non-leaf nodes (illustrated in FIG. 7 with solid-line boxes) bottom-up, by the weighted sum of its leaf nodes (such as children) such that, for a given non-leaf node, the score s is equal to

$$s = \frac{\sum w \times score}{\sum w} ,$$

with w denoting a weighting for a specific score (such that different scores may have different weightings). For example, the workload scheduler device 305 may calculate s_{usage} in accordance with Equation 8, shown below, where w_{d}=w_{duration of usage}, wₐ=w_{amount of computation}, s_{d}=s_{duration of usage}, and sₐ=s_{amount of computation}.

$${s}_{usage} = \frac{( {w}_{d} \times {s}_{d} ) + ( {w}_{a} \times {s}_{a} )}{{w}_{d} + {w}_{a}} \qquad ( 8 )$$

In some aspects, the workload scheduler device 305 may set all weightings (which may be equivalently referred to herein as weights) to be equal to a default value (such as a one value) in a distributed computing phase 1, and may adjust the weightings over time based on previous assignments and historical data. Additionally, or alternatively, an application developer or end user may specify the weightings of different resources as part of defining (such as indicating or configuring) the workload inputs.

In some implementations, the workload scheduler device 305 may normalize the score for each resource (a resource being, for example, a quantifiable hardware resource or computation metric 710, a communication metric 715, a power supply metric 720, or a host reliability metric 725) given a list of the scores for that resource across the host devices 210 within the feasible host set. For example, given a set of throughput margin scores of s=[1, 3, 7, 8, 21] across a set of five host devices 210 within a feasible host set, the workload scheduler device 305 may normalize the throughput margin scores in accordance with Equation 9, shown below, to obtain updated (such as normalized) scores s′. In accordance with the normalization of scores of each resource, the updated/normalized scores of each resource may be in a range of s′=[0,1]. Further, if sₘₐₓ=sₘᵢₙ, s′=1 for all host devices 210 within the feasible host set.

$${s}^{′} = \frac{s - {s}_{min}}{{s}_{max} - {s}_{min}} \qquad ( 9 )$$

The following relates to an example in which the workload scheduler device 305 calculates, determines, or otherwise obtains scores 705 for three host devices 210 including a first host device 210 (such as a host device 1), a second host device 210 (such as a host device 2), and third host device 210 (such as a host device 3) and in which the workload scheduler device 305 accounts for a computation metric 710, a communication metric 715, a power supply metric 720, and a host reliability metric 725. In such an example, the workload scheduler device 305 may obtain a first score 705 for the first host device 210, a second score 705 for the second host device 210, and a third score 705 for the third host device 210 in accordance with scoring functions across each resource and weighted sums at each non-leaf node of the scoring hierarchy 700. Table 1, shown below, illustrates an example pre-normalized set of scores for a set of resources associated with the computation metric 710 for each of the three host devices.

TABLE 1
Computation Resource Scores Pre-Normalization

| Host | CPU | GPU | Memory | Storage | NPU |
|---|---|---|---|---|---|
| Device | Score | Score | Score | Score | Score |
| Host | 0.3 | 0.2 | 0.9 | 0.9 | 0.4 |
| Device 1 | | | | | |
| Host | 0.8 | 0.6 | 0.9 | 0.1 | 0.8 |
| Device 2 | | | | | |
| Host | 0.4 | 0.4 | 0.1 | 0.8 | 0.4 |
| Device 3 | | | | | |

In some examples, the workload scheduler device 305 may normalize the various resource scores with respect to scores across the set of host devices 210. The workload scheduler device 305 may normalize the scores in accordance with Equation 9, shown above. In accordance with normalizing the various scores, the workload scheduler device 305 may obtain updated (such as normalized) scores as illustrated by Table 2, shown below.

TABLE 2
Computation Resource Scores Post-
Normalization and Pre-Summation

| Host | CPU | GPU | Memory | Storage | NPU |
|---|---|---|---|---|---|
| Device | Score | Score | Score | Score | Score |
| Host | 0 | 0 | 1 | 1 | 0 |
| Device 1 | | | | | |
| Host | 1 | 1 | 1 | 0 | 1 |
| Device 2 | | | | | |
| Host | 0.2 | 0.5 | 0 | 0.875 | 0 |
| Device 3 | | | | | |

In accordance with normalizing the computation resource scores, the workload scheduler device 305 may calculate a weighted sum for each host device 210. Such a weighted sum may be the computation metric 710. In accordance with performing the weighted sum, and in examples in which the weightings on the various scores are equal to 1, the workload scheduler device 305 may obtain a first computation metric 710 for the first host device 210 of 0.4, may obtain a second computation metric 710 for the second host device 210 of 0.8, and may obtain a third computation metric 710 for the third host device 210 of 0.32. In accordance with obtaining the computation metrics 710 (such as the computation or compute scores) for the first host device 210, the second host device 210, and the third host device 210, the workload scheduler device 305 may calculate a respective score 705 for each of the three host devices in accordance with factoring in a communication metric 715, a power supply metric 720, and a reliability metric 725. Table 3, shown below, illustrates an example set of scores for the three host devices across computation metrics 710, communication metrics 715, power supply metrics 720, and reliability metrics 725. The metrics may be shown pre-normalization across the different host devices 210.

TABLE 3
Computation, Communication, Power Supply,
and Reliability Scores Pre-Normalization

| | | | Power | |
|---|---|---|---|---|
| Host | Computation | Communication | Supply | Reliability |
| Device | Score | Score | Score | Score |
| Host | 0.4 | 15 | 1 | 3 |
| Device 1 | | | | |
| Host | 0.8 | 5 | 1 | 6 |
| Device 2 | | | | |
| Host | 0.32 | 12 | 1 | 9 |
| Device 3 | | | | |

In some examples, the workload scheduler device 305 may normalize the computation metrics 710, the communication metrics 715, the power supply metrics 720, and the reliability metrics 725 with respect to scores across the set of host devices 210. The workload scheduler device 305 may normalize the metrics or scores in accordance with Equation 9, shown above. In accordance with the normalization, the workload scheduler device 305 may obtain updated (such as normalized) scores as illustrated by Table 4, shown below.

TABLE 4
Computation, Communication and Power
Supply Scores Post-Normalization

| | | | Power | |
|---|---|---|---|---|
| Host | Computation | Communication | Supply | Reliability |
| Device | Score | Score | Score | Score |
| Host | 0.17 | 1 | 1 | 0 |
| Device 1 | | | | |
| Host | 1 | 0 | 1 | 0.5 |
| Device 2 | | | | |
| Host | 0 | 0.7 | 1 | 1 |
| Device 3 | | | | |

In accordance with normalizing the scores, the workload scheduler device 305 may calculate a weighted sum for each host device 210. Such a weighted sum may be the score 705. In accordance with performing the weighted sum, and in examples in which the weightings on the various scores are equal to 1, the workload scheduler device 305 may obtain a first score 705 for the first host device 210 of 0.54, may obtain a second score 705 for the second host device 210 of 0.63, and may obtain a third score 705 for the third host device 210 of 0.68. In such examples, the workload scheduler device 305 may rank the third host device 210 ahead of the second host device 210 and may rank the second host device 210 ahead of the first host device 210 in accordance with their respective scores 705. In accordance with the top ranking of the third host device 210, the workload scheduler device 305 may transmit an indication of an assignment of the workload to at least the third host device 210.

In some implementations, the workload scheduler device 305 may split a workload across multiple host devices 210 or may duplicate a workload on multiple host devices 210. In such implementations, the workload scheduler device 305 may select multiple host devices 210 with the relatively highest rankings (such as the host devices 210 with the relatively greatest scores, the relatively lowest scores, or the scores relatively closest to a target score) and may split a workload among the selected host devices 210 or duplicate the workload among the selected host devices 210. In other words, the workload scheduler device 305 may transmit multiple indications of multiple assignments of the workload to a set of host devices 210, with such multiple assignments referring to the workload in part or in entirety. In some aspects, the workload scheduler device 305 may segment or split the workload into multiple portions and may assign a portion to a specific host device 210 in accordance with that host device 210 being relatively more suitable (in accordance with one or more metrics associated with that host device 210) for one or more characteristics associated with that portion of the workload. Thus, unless otherwise explicitly indicated, an assignment of a workload to a host device 210 may be understood as an assignment of a complete workload (such as in its entirety) or as an assignment of a portion of a workload.

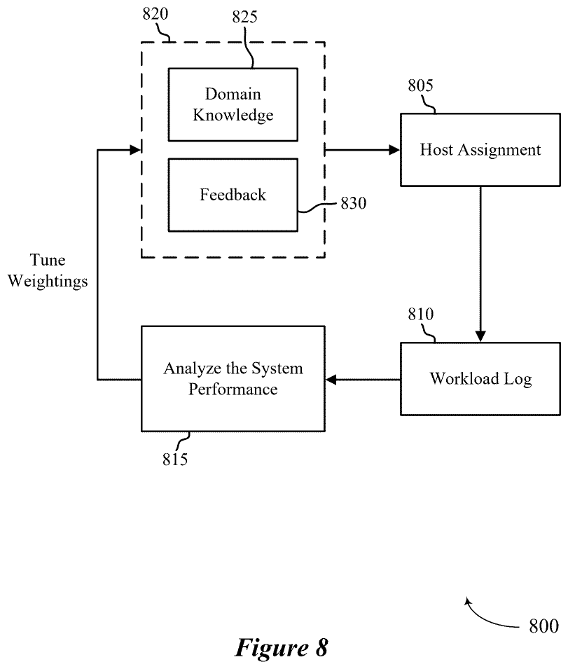

In some implementations, the workload scheduler device 305 may have learning capabilities and may weight configuration or host selection through learning that is informed by or otherwise in accordance with past (such as previous) workload logs. With such learning capabilities, the workload scheduler device 305 may define (such as configure or set) the performance metrics for the orchestration or scheduling design or may perform joint configuration (such as joint optimization) of orchestration for an entire system (as opposed to for a single workload). Additional details relating to such learning capabilities are illustrated by and described with reference to FIG. 8.

FIG. 8 shows an example scoring adaptation algorithm 800 that supports workload scheduling in edge computing. In some examples, a workload scheduler device 305 may leverage or use the scoring adaptation algorithm 800 to configure, set, update, tune, or adjust one or more weightings associated with a weighted sum-based scoring for each of various feasible host devices 210, with such a weighted sum-based scoring being an example of the scoring 535 as illustrated by and described with reference to FIG. 5. For example, the workload scheduler device 305 may perform a joint evaluation for each host device 210 within a feasible host set to obtain weighted sum scores for each host device 210 and may configure, set, update, tune, or adjust the weightings periodically or aperiodically in accordance with system performance, feedback, or user settings.

For example, the workload scheduler device 305 may perform a host assignment 805 associated with a requested workload in accordance with a first set of weightings. In accordance with the host assignment 805, the workload scheduler device 305 may obtain, receive, or retrieve a workload log 810 and may perform an analysis 815 of the system performance in association with evaluating the workload log 810. In some examples, the workload scheduler device 305 may identify a bottleneck of a workload in association with evaluating the workload log 810 and analyzing the system performance. Such a bottleneck may be computation-bound, communication-bound, or the like.

In some examples, the workload scheduler device 305 may tune (such as configure, set, update, or adjust) one or more weightings of the first set of weightings associated with the weighted sum scoring in accordance with the workload log 810 (or multiple workload logs 810), a workload type, or workload expectations. In such examples, the workload scheduler device 305 may tune the one or more weightings in accordance with one or both of domain knowledge 825 or feedback 830. Additionally, or alternatively, the workload scheduler device 305 may treat a box 820 (including the domain knowledge 825 and the feedback 830) as a block box and the workload scheduler device 305 may attempt to learn the box 820 via a learning capability (such as a learning algorithm) of the workload scheduler device 305. In other words, the workload scheduler device 305 may use the box 820 as a weighting configuration or may treat the scoring as a block box. In accordance with the adaptation algorithm 800, the workload scheduler device 305 may update the first set of weightings to a second set of weightings and may use the second set of weightings for subsequent scoring (such as for subsequent joint evaluations associated with subsequent workload requests).

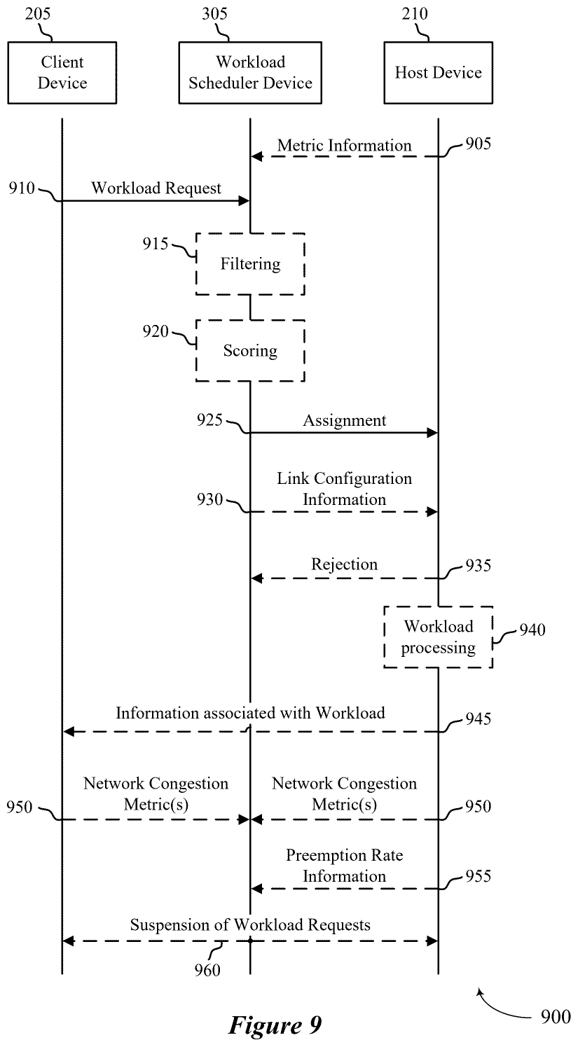

FIG. 9 shows an example process flow 900 that supports workload scheduling in edge computing. The process flow 900 may implement or be implemented to realize one or more aspects of the wireless communication system 100, the connected edge cluster architecture 200, the signaling diagram 300, the workload scheduling diagram 400, the nested workload scheduling algorithm 401, the workload deployment algorithm 500, the filtering procedure 600, the scoring hierarchy 700, and the adaptation algorithm 800. For example, the process flow 900 illustrates communication between a client devices 205, a workload scheduler device 305, and a host device 210.

Alternative examples of the following may be implemented. Some steps are performed in a different order than described or are not performed at all. In some implementations, steps may include additional features not mentioned below, or further steps may be added. Further, although example devices are shown performing the operations of the process flow 900, some aspects of some operations also may be performed by one or more other wireless communication devices without exceeding the scope of the present disclosure.

At 905, the workload scheduler device 305 may receive, from the host device 210, information indicative of a set of one or more computation metrics associated with the host device 210, a set of one or more communication metrics associated with the host device 210, a set of one or more power supply metrics associated with the host device 210, and a set of one or more reliability metrics associated with the host device 210. Further, in some implementations, the workload scheduler device 305 may receive respective information of such metrics from each host device 210 of a set of host devices 210. In such implementations, the workload scheduler device 305 may receive, from each host device 210, information indicative of a respective set of one or more computation metrics associated with that host device 210, a respective set of one or more communication metrics associated with that host device 210, a respective set of one or more power supply metrics associated with that host device 210, and a respective set of one or more reliability metrics associated with that host device 210.

At 910, the workload scheduler device 305 may receive, from the client device 205, a workload request. For example, the workload scheduler device 305 may receive a request associated with a workload. In some implementations, the workload scheduler device 305 may receive, via the workload request or via other signaling or messaging, information indicative of one or more parameters associated with the workload.

At 915, the workload scheduler device 305 may perform a filtering, such as a filtering 515 as illustrated by and described with reference to FIG. 5. Further, in some aspects, such filtering may include a series or sequence of steps of a filtering procedure, such as the filtering procedure 600 as illustrated by and described with reference to FIG. 6. In accordance with the filtering, the workload scheduler device 305 may obtain identifying information for (such as IDs of) a set of host devices 210 from a larger set of potential host devices in association with evaluating each host device 210 of the larger set of host devices 210. The workload scheduler device 305 may evaluate each host device 210 in accordance with the parameter(s) associated with the workload and one or more variants of the workload. Such a set of host devices 210 may be understood as a feasible host set, and may include one or multiple members. Some example variants of the workload may include a workload variant 510-a, a workload variant 510-b, and a workload variant 510-c as illustrated by and described with reference to FIG. 5.

At 920, the workload scheduler device 305 may perform a scoring, such as a scoring 535 as illustrated by and described with reference to FIG. 5. Further, in some aspects, such scoring may be in accordance with a scoring hierarchy, such as the scoring hierarchy 700 as illustrated by and described with reference to FIG. 7. In accordance with the scoring, the workload scheduler device 305 may obtain a set of scores (such as a set of scores 705) for the set of host devices 210 (such as for host devices 210 within the feasible host set) in accordance with a respective joint evaluation, for each host device 210 of the set of host devices 210 and in accordance with the parameter(s) associated with the workload, of one or more computation metrics, one or more communication metrics, one or more power supply metrics, and one or more reliability metrics. Such metrics may include the one or more computation metrics 710, the one or more communication metrics 715, the one or more power supply metrics 720, and the one or more host reliability metrics 725 as illustrated by and described with reference to FIG. 7.

At 925, in accordance with the scoring, the workload scheduler device 305 may transmit an indication of an assignment of the workload to at least the host device 210. In some implementations, the workload scheduler device 305 may assign the workload to the host device 210 in accordance with a first score for the host device 210 being relatively greater than one or more scores for a remainder of the set of host devices 210.

At 930, the workload scheduler device 305 may transmit, to the host device 210 or another edge device (such as a network device, such as an AP, gNB, or router, serving the host device 210), link configuration information. In some implementations, the workload scheduler device 305 may transmit the link configuration information in association with receiving, from the host device 210, information indicating that the host device 210 is processing connected edge workloads (such as distributed computing workloads). Additionally, or alternatively, a network device (such as a Wi-Fi AP or a cellular gNB) may transmit the link configuration information to the host device 210. The link configuration information may include an indication to move or steer the host device 210 to a different channel, to a different RF band, or to a different network device. For example, the link configuration information may steer the host device 210 to a first network device from a second network device. In such examples, the workload scheduler device 305 may steer the host device 210 to the first network device in accordance with the first network device being a relatively more reliable or efficient network device in terms of supporting the connected edge workloads at the host device 210.

At 935, the host device 210 may transmit, to the workload scheduler device 305, an indication of a rejection of the assignment of the workload to the host device 210. In some implementations, the host device 210 may transmit the indication of the rejection in accordance with one or more percentage metrics associated with an amount of resources used for connected edge workloads, including the assigned workload, at the host device 210 exceeding one or more threshold percentages. Such one or more threshold percentages may include the third threshold percentage x₃% as described with reference to FIG. 3.

At 940, the host device 210, if the host device 210 accepts the assigned workload (which the host device 210 may signal to the workload scheduler device 305 or which may be implied in the absence of a rejection at 935), may perform a workload processing. In other words, the host device 210 may perform one or more processing operations or tasks associated with the assigned workload.

At 945, the host device 210 may transmit, to the client device 205, information associated with the workload in accordance with the assignment of the workload to at least the host device 210 (and in accordance with processing the workload at 940). Such information may include one or more outputs or a result associated with the workload, such as one or more rendered images, one or more computation results, processed visual or audio data, or the like.

At 950, the workload scheduler device 305 may receive, from one or both of the client device 205 or the host device 210, information indicative of one or more network congestion metrics. In some aspects, such one or more network congestion metrics may be associated with a cluster (such as a distributed computing cluster) of edge devices including the feasible host set.

At 955, the host device 210 may transmit, to the workload scheduler device 305, information indicative of a preemption rate associated with workloads assigned to the host device 210. Additionally, in some implementations, the workload scheduler device 305 may receive similar information for multiple host devices 210 indicating that a preemption rate associated with workloads assigned to a cluster of edge devices.

At 960, if the network congestion metric(s) indicate that the network is congested or if the preemption rate exceeds (such as fails to satisfy) a threshold preemption rate, the workload scheduler device 305 may transmit an indication of a suspension of workload requests. Such a suspension of workload requests may be to suspend or reject workloads of a specific type or may be to suspend or reject workloads of any type. For example, if the network congestion metric(s) indicate that the network is congested, the workload scheduler device 305 may suspend or reject workloads associated with a session-oriented workload type. Additionally, or alternatively, if the preemption rate exceeds the threshold preemption rate, the workload scheduler device 305 may suspend or reject workloads associated with any workload type.

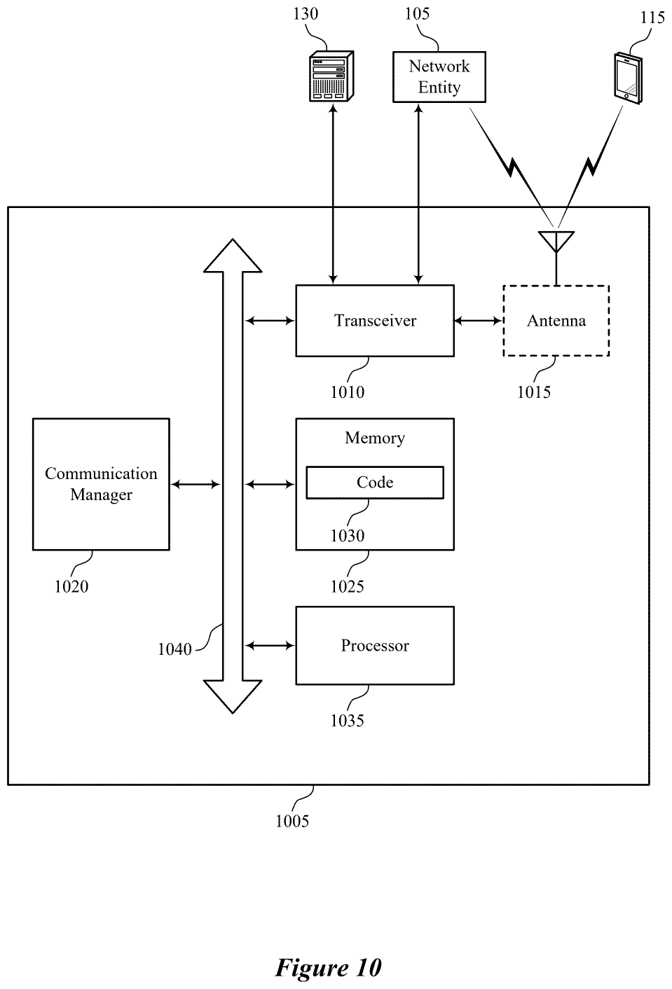

FIG. 10 shows a block diagram of an example device 1005 that supports workload scheduling in edge computing. The device 1005 may communicate with one or more workload scheduling devices, one or more host devices, one or more client devices, one or more network entities 105, one or more UEs 115, or any combination thereof, which may include communications over one or more wired interfaces, over one or more wireless interfaces, or any combination thereof. The device 1005 may include components that support outputting and obtaining communications, such as a communication manager 1020, a transceiver 1010, one or more antennas 1015, at least one memory 1025, code 1030, and at least one processor 1035. These components may be in electronic communication or otherwise coupled (such as operatively, communicatively, functionally, electronically, electrically) via one or more buses (such as a bus 1040).

The transceiver 1010 may support bi-directional communications via wired links, wireless links, or both as described herein. In some implementations, the transceiver 1010 may include a wired transceiver and may communicate bi-directionally with another wired transceiver. Additionally, or alternatively, in some implementations, the transceiver 1010 may include a wireless transceiver and may communicate bi-directionally with another wireless transceiver. In some implementations, the device 1005 may include one or more antennas 1015, which may be capable of transmitting or receiving wireless transmissions (such as concurrently). The transceiver 1010 also may include a modem to modulate signals, to provide the modulated signals for transmission (such as by one or more antennas 1015 or by a wired transmitter), to receive modulated signals (such as from one or more antennas 1015 or from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations in accordance with received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (such as the at least one processor 1035, the at least one memory 1025, or both), may be included in a chip or chip assembly that is installed in the device 1005. In some implementations, the transceiver 1010 may be operable to support communications via one or more communications links (such as communication link(s) 125, backhaul communication link(s) 120, a midhaul communication link 162, a fronthaul communication link 168).

The at least one memory 1025 may include random-access memory (RAM), read-only memory (ROM), or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some implementations, the code 1030 may not be directly executable by a processor of the at least one processor 1035 but may cause a computer (such as when compiled and executed) to perform functions described herein. In some implementations, the at least one memory 1025 may include, among other things, a basic input/output (I/O) system (BIOS) which may control basic hardware or software operation such as the interaction with peripheral components or devices. In some implementations, the at least one processor 1035 may include multiple processors and the at least one memory 1025 may include multiple memories. One or more of the multiple processors may be coupled with one or more of the multiple memories which may, individually or collectively, be configured to perform various functions described herein (such as, part of a processing system, a memory system, or both).

The at least one processor 1035 may include one or more intelligent hardware devices (such as one or more general-purpose processors, one or more digital signal processors (DSPs), one or more CPUs, one or more GPUs, one or more NPUs (also referred to as neural network processors or deep learning processors (DLPs)), one or more microcontrollers, one or more application-specific integrated circuits (ASICs), one or more field-programmable gate arrays (FPGAs), one or more programmable logic devices, discrete gate or transistor logic, one or more discrete hardware components, or any combination thereof). In some implementations, the at least one processor 1035 may be configured to operate a memory array using a memory controller. In some other implementations, a memory controller may be integrated into one or more of the at least one processor 1035. The at least one processor 1035 may be configured to execute computer-readable instructions stored in a memory (such as one or more of the at least one memory 1025) to cause the device 1005 to perform various functions (such as functions or tasks supporting workload scheduling in edge computing). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (such as one or more physical nodes and supporting software such as operating systems, virtual machines, or container instances) that may host the functions (such as by executing code 1030) to perform the functions of the device 1005. The at least one processor 1035 may be any one or more suitable processors capable of executing scripts or instructions of one or more software programs stored in the device 1005 (such as within one or more of the at least one memory 1025). In some implementations, the at least one processor 1035 may include multiple processors and the at least one memory 1025 may include multiple memories. One or more of the multiple processors may be coupled with one or more of the multiple memories, which may, individually or collectively, be configured to perform various functions herein.

In some implementations, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some implementations, a processing system of the device 1005 may refer to a system including the various other components or subcomponents of the device 1005, such as the at least one processor 1035, or the transceiver 1010, or the communication manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both.

The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

The device 1005 may include one or more chips, SoCs, chipsets, packages or devices that individually or collectively constitute or include a processing system. The processing system includes processor (or “processing”) circuitry in the form of one or multiple processors, microprocessors, processing units (such as CPUs, GPUs, NPUs, or DSPs), processing blocks, ASIC, programmable logic devices (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers.

In some implementations, a bus 1040 may support communications of (such as within) a protocol layer of a protocol stack. In some implementations, a bus 1040 may support communications associated with a logical channel of a protocol stack (such as between protocol layers of a protocol stack), which may include communications performed within a component of the device 1005, or between different components of the device 1005 that may be co-located or located in different locations (such as where the device 1005 may refer to a system in which one or more of the communication manager 1020, the transceiver 1010, the at least one memory 1025, the code 1030, and the at least one processor 1035 may be located in one of the different components or divided between different components).

In some implementations, the communication manager 1020 may manage aspects of communications with a core network 130 (such as via one or more wired or wireless backhaul links). For example, the communication manager 1020 may manage the transfer of data communications for client devices, such as one or more UEs 115. In some implementations, the communication manager 1020 may manage communications with one or more other network entities 105, and may include a controller or scheduler for controlling communications with UEs 115 (such as in cooperation with the one or more other network devices). In some implementations, the communication manager 1020 may support an X2 interface within an LTE/LTE-A wireless communications network technology to provide communication between network entities 105.

In some implementations, the communication manager 1020 (and, likewise, the device 1005) may support connected edge workload scheduling as or as a component of a workload scheduler device in accordance with examples as disclosed herein. The communication manager 1020 is capable of, configured to, or operable to support a means for receiving, via a request associated with a workload, information indicative of one or more parameters associated with the workload. In some examples, the communication manager 1020 is capable of, configured to, or operable to support a means for transmitting an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

In some examples, the communication manager 1020 is capable of, configured to, or operable to support a means for receiving, from the first host device, information associated with the first set of one or more computation metrics, the first set of one or more communication metrics, the first set of one or more power supply metrics, and the first set of one or more reliability metrics.

In some examples, the communication manager 1020 is capable of, configured to, or operable to support a means for obtaining a set of scores for a set of host devices including the first host device in accordance with a respective joint evaluation associated with each host device of a set of host devices, where each score of the set of scores is for a respective host device of the set of host devices, and where the assignment of the workload to at least the first host device is in accordance with a first score for the first host device being relatively greater than one or more scores for a remainder of the set of host devices excluding the first host device.

In some examples, the communication manager 1020 is capable of, configured to, or operable to support a means for receiving, from each host device of the set of host devices, information associated with a respective set of one or more computation metrics associated with that host device, a respective set of one or more communication metrics associated with that host device, a respective set of one or more power supply metrics associated with that host device, and a respective set of one or more reliability metrics associated with that host device, where the respective joint evaluation associated with each host device of the set of host devices is in accordance with the information received from each host device of the set of host devices.

In some examples, to support obtaining the set of scores for the set of host devices, the communication manager 1020 is capable of, configured to, or operable to support a means for obtaining the first score for the first host device in accordance with the first joint evaluation. In some examples, to support obtaining the set of scores for the set of host devices, the communication manager 1020 is capable of, configured to, or operable to support a means for obtaining a second score for a second host device of the set of host devices in accordance with a second joint evaluation, associated with the one or more parameters, of a second set of one or more computation metrics associated with the second host device, a second set of one or more communication metrics associated with the second host device, a second set of one or more power supply metrics associated with the second host device, and a second set of one or more reliability metrics associated with the second host device, where the first score is relatively greater than the second score.

In some examples, each score of the set of scores is a respective weighted sum of a respective set of one or more computation metrics, a respective set of one or more communication metrics, a respective set of one or more power supply metrics, and a respective set of one or more reliability metrics.

In some examples, to obtain the respective weighted sum, a first weighting is applied to the respective set of one or more computation metrics, a second weighting is applied to the respective set of one or more communication metrics, a third weighting is applied to the respective set of one or more power supply metrics, and a fourth weighting is applied to the respective set of one or more reliability metrics.

In some examples, the communication manager 1020 is capable of, configured to, or operable to support a means for obtaining an indication of the first weighting, the second weighting, the third weighting, and the fourth weighting in accordance with historical data associated with workload scheduling across the set of host devices or the one or more parameters associated with the workload.

In some examples, the communication manager 1020 is capable of, configured to, or operable to support a means for obtaining a set of host devices from a set of multiple host devices in association with evaluating each host device of the set of multiple host devices in accordance with the one or more parameters and one or more variants of the workload, where the set of host devices includes the first host device.

In some examples, to support evaluating each host device of the set of multiple host devices, the communication manager 1020 is capable of, configured to, or operable to support a means for evaluating whether the workload is feasible for a respective host device of the set of multiple host devices in accordance with the one or more parameters, a respective set of one or more variants of the workload, and a capability of the respective host device.

In some examples, the capability of the respective host device is associated with one or more percentage metrics associated with an amount of resources used for one or more existing edge compute workloads at the respective host device, one or more memory usage metrics, one or more storage usage metrics, one or more power metrics at the respective host device, a software or hardware capability of the respective host device, or one or more communication metrics associated with over-the-air signaling between the respective host device and a client device associated with the workload.

In some examples, the communication manager 1020 is capable of, configured to, or operable to support a means for including the first host device in the set of host devices in accordance with the workload being feasible for the first host device, where the workload is feasible for the first host device in accordance with the one or more parameters, a first set of one or more variants of the workload, and a first capability of the first host device. In some examples, the communication manager 1020 is capable of, configured to, or operable to support a means for excluding a second host device of the set of multiple host devices from the set of host devices in accordance with the workload being unfeasible for the second host device, where the workload is unfeasible for the second host device in accordance with the one or more parameters, a second set of one or more variants of the workload, and a second capability of the first host device.

In some examples, the communication manager 1020 is capable of, configured to, or operable to support a means for receiving, from the first host device, a rejection of the assignment of the workload to the first host device in accordance with one or more percentage metrics associated with an amount of resources used for one or more edge compute workloads, including the workload, at the first host device exceeding one or more threshold percentages.

In some examples, the communication manager 1020 is capable of, configured to, or operable to support a means for transmitting an indication of an updated assignment of the workload to at least a second host device in association with receiving the rejection of the assignment of the workload to the first host device.

In some examples, the communication manager 1020 is capable of, configured to, or operable to support a means for receiving information indicating that the first host device is processing edge compute workloads, the edge compute workloads including the workload assigned to the first host device. In some examples, the communication manager 1020 is capable of, configured to, or operable to support a means for transmitting, to the first host device or a first network device associated with the first host device, link configuration information that steers the first host device to the first network device from a second network device in association with the first host device processing the edge compute workloads.

In some examples, the communication manager 1020 is capable of, configured to, or operable to support a means for receiving information indicative of one or more network congestion metrics associated with a cluster of edge devices including the first host device. In some examples, the communication manager 1020 is capable of, configured to, or operable to support a means for transmitting an indication of a suspension of workload requests associated with a session-oriented workload type in accordance with the one or more network congestion metrics.

In some examples, the communication manager 1020 is capable of, configured to, or operable to support a means for receiving information indicating that a preemption rate associated with workloads assigned to a cluster of edge devices including the first host device exceeds a threshold preemption rate. In some examples, the communication manager 1020 is capable of, configured to, or operable to support a means for transmitting an indication of a suspension of workload requests in accordance with the preemption rate exceeding the threshold preemption rate.

In some examples, the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

In some examples, the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage associated with the one or more local applications, an indication of one or more existing edge compute workloads, or one or more percentage metrics associated with an amount of resources used for the one or more existing edge compute workloads.

In some examples, the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Additionally, or alternatively, the communication manager 1020 (and, likewise, the device 1005) may support connected edge workload scheduling as or as a component of a host device in accordance with examples as disclosed herein. In some examples, the communication manager 1020 is capable of, configured to, or operable to support a means for transmitting, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device. In some examples, the communication manager 1020 is capable of, configured to, or operable to support a means for receiving, from the workload scheduler device, an indication of an assignment of a workload to at least the first host device in accordance with at least a first joint evaluation, associated with one or more parameters, of the first set of one or more computation metrics, the first set of one or more communication metrics, the first set of one or more power supply metrics, and the first set of one or more reliability metrics.

In some examples, the communication manager 1020 is capable of, configured to, or operable to support a means for transmitting, to a client device requesting the workload, information associated with the workload in accordance with the assignment of the workload to at least the first host device.

In some examples, the communication manager 1020 is capable of, configured to, or operable to support a means for transmitting, to the workload scheduler device, a rejection of the assignment of the workload to the first host device in accordance with one or more percentage metrics associated with an amount of resources used for one or more edge compute workloads, including the workload, at the first host device exceeding one or more threshold percentages.

In some examples, the communication manager 1020 is capable of, configured to, or operable to support a means for transmitting, to the workload scheduler device, information indicating that the first host device is processing edge compute workloads, the edge compute workloads including the workload assigned to the first host device. In some examples, the communication manager 1020 is capable of, configured to, or operable to support a means for receiving link configuration information that steers the first host device to a first network device from a second network device in association with the first host device processing the edge compute workloads.

In some examples, the communication manager 1020 is capable of, configured to, or operable to support a means for receiving, from the workload scheduler device, an indication of a suspension of workload requests associated with a session-oriented workload type in accordance with one or more network congestion metrics.

In some examples, the communication manager 1020 is capable of, configured to, or operable to support a means for transmitting, to the workload scheduler device, information indicative of one or more network congestion metrics associated with a cluster of edge devices including the first host device.

In some examples, the communication manager 1020 is capable of, configured to, or operable to support a means for receiving, from the workload scheduler device, an indication of a suspension of workload requests in accordance with a preemption rate associated with workloads assigned to a cluster of edge devices including the first host device exceeding a threshold preemption rate.

In some examples, the communication manager 1020 is capable of, configured to, or operable to support a means for transmitting, to the workload scheduler device, information indicating that a preemption rate at the first host device exceeds a threshold preemption rate.

In some examples, the communication manager 1020 is capable of, configured to, or operable to support a means for preempting one or more workloads assigned to the first host device in accordance with one or more network changes, cluster exits, higher-priority edge compute workload launches, or local application launches, where transmitting the information indicating that the preemption rate at the first host device exceeds the threshold preemption rate is in association with preempting the one or more workloads.

In some examples, the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

In some examples, the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

In some examples, the one or more parameters associated with the workload include a workload type, an indication of an affinity of the workload, a requested completion time, a requested power source or battery power metric, a requested software or hardware capability, one or more weightings associated with the first joint evaluation, or a requested SLA.

In some examples, the communication manager 1020 may be configured to perform various operations (such as receiving, obtaining, monitoring, outputting, transmitting) using or otherwise in cooperation with the transceiver 1010, the one or more antennas 1015 (such as where applicable), or any combination thereof. Although the communication manager 1020 is illustrated as a separate component, in some examples, one or more functions described with reference to the communication manager 1020 may be supported by or performed by the transceiver 1010, one or more of the at least one processor 1035, one or more of the at least one memory 1025, the code 1030, or any combination thereof (such as by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of workload scheduling in edge computing as described herein, or the at least one processor 1035 and the at least one memory 1025 may be otherwise configured to, individually or collectively, perform or support such operations.

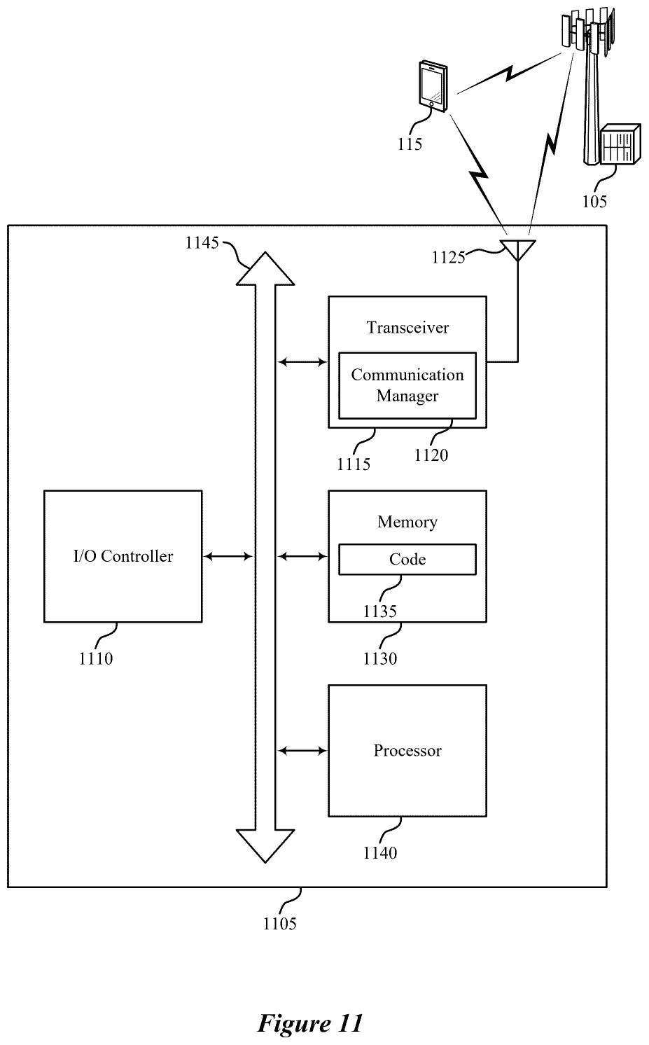

FIG. 11 shows a block diagram of an example device 1105 that supports workload scheduling in edge computing. The device 1105 may communicate with one or more workload scheduling devices, one or more host devices, one or more network entities 105, one or more UEs 115, or any combination thereof, which may include communications over one or more wired interfaces, over one or more wireless interfaces, or any combination thereof. The device 1105 may include components for bi-directional voice and data communications including components for transmitting and receiving communications, such as a communication manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (such as operatively, communicatively, functionally, electronically, electrically) via one or more buses (such as a bus 1145).

The I/O controller 1110 may manage input and output signals for the device 1105. The I/O controller 1110 also may manage peripherals not integrated into the device 1105. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some implementations, the I/O controller 1110 may be implemented as part of a processor or processing system, such as the processor 1140. In some implementations, a user may interact with the device 1105 via the I/O controller 1110 or via hardware components controlled by the I/O controller 1110.

In some implementations, the device 1105 may include a single antenna. However, in some other implementations, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 also may include a modem to modulate the packets, to provide the modulated packets to one or more antennas 1125 for transmission, and to demodulate packets received from the one or more antennas 1125. In some implementations, the transceiver 1115 may include one or more interfaces, such as one or more interfaces coupled with the one or more antennas 1125 that are configured to support various receiving or obtaining operations, or one or more interfaces coupled with the one or more antennas 1125 that are configured to support various transmitting or outputting operations, or a combination thereof. In some implementations, the transceiver 1115 may include or be configured for coupling with one or more processors or memory components that are operable to perform or support operations based on received or obtained information or signals, or to generate information or other signals for transmission or other outputting, or any combination thereof. In some implementations, the transceiver 1115, or the transceiver 1115 and the one or more antennas 1125, or the transceiver 1115 and the one or more antennas 1125 and one or more processors or memory components (such as the processor 1140, or the memory 1130, or both), may be included in a chip or chip assembly that is installed in the device 1105.

The at least one memory 1130 may include RAM, ROM, or any combination thereof. The at least one memory 1130 may store computer-readable, computer-executable, or processor-executable code, such as code 1135. The code 1135 may include instructions that, when executed by one or more of the at least one processor 1140, cause the device 1105 to perform various functions described herein. The code 1135 may be stored in a non-transitory computer-readable medium such as system memory or another type of memory. In some implementations, the code 1135 may not be directly executable by a processor of the at least one processor 1140 but may cause a computer (such as when compiled and executed) to perform functions described herein. In some implementations, the at least one memory 1130 may include, among other things, a basic I/O system (BIOS) which may control basic hardware or software operation such as the interaction with peripheral components or devices. In some implementations, the at least one processor 1140 may include multiple processors and the at least one memory 1130 may include multiple memories. One or more of the multiple processors may be coupled with one or more of the multiple memories which may, individually or collectively, be configured to perform various functions herein (such as part of a processing system, a memory system, or both).

The at least one processor 1140 may include one or more intelligent hardware devices (such as one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some examples, the at least one processor 1140 may be configured to operate a memory array using a memory controller. In some other cases, a memory controller may be integrated into one or more of the at least one processor 1140. The at least one processor 1140 may be configured to execute computer-readable instructions stored in a memory (such as one or more of the at least one memory 1130) to cause the device 1105 to perform various functions (such as functions or tasks supporting workload scheduling in edge computing). For example, the device 1105 or a component of the device 1105 may include at least one processor 1140 and at least one memory 1130 coupled with one or more of the at least one processor 1140, the at least one processor 1140 and the at least one memory 1130 configured to perform various functions described herein. The at least one processor 1140 may be an example of a cloud-computing platform (such as one or more physical nodes and supporting software such as operating systems, virtual machines, or container instances) that may host the functions (such as by executing code 1135) to perform the functions of the device 1105. The at least one processor 1140 may be any one or more suitable processors capable of executing scripts or instructions of one or more software programs stored in the device 1105 (such as within one or more of the at least one memory 1130). In some implementations, the at least one processor 1140 may include multiple processors and the at least one memory 1130 may include multiple memories. One or more of the multiple processors may be coupled with one or more of the multiple memories, which may, individually or collectively, be configured to perform various functions herein.

In some implementations, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

In some implementations, a processing system of the device 1105 may refer to a system including the various other components or subcomponents of the device 1105, such as the at least one processor 1140, or the transceiver 1115, or the communication manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both.

The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

The device 1105 may include one or more chips, SoCs, chipsets, packages or devices that individually or collectively constitute or include a processing system. The processing system includes processor (or “processing”) circuitry in the form of one or multiple processors, microprocessors, processing units (such as CPUs, GPUs, NPUs, or DSPs), processing blocks, ASICs, programmable logic devices (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains, or transceivers.

In some implementations, a bus 1145 may support communications of (such as within) a protocol layer of a protocol stack. In some implementations, a bus 1145 may support communications associated with a logical channel of a protocol stack (such as between protocol layers of a protocol stack), which may include communications performed within a component of the device 1105, or between different components of the device 1105 that may be co-located or located in different locations (such as where the device 1105 may refer to a system in which one or more of the communication manager 1120, the transceiver 1115, the at least one memory 1130, the code 1135, and the at least one processor 1140 may be located in one of the different components or divided between different components).

The communication manager 1120 (and, likewise, the device 1105) may support connected edge workload scheduling as or as a component of a client device in accordance with examples as disclosed herein. The communication manager 1120 is capable of, configured to, or operable to support a means for transmitting, via a request associated with a workload, information indicative of one or more parameters associated with the workload. In some examples, the communication manager 1120 is capable of, configured to, or operable to support a means for receiving information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

In some examples, the communication manager 1120 is capable of, configured to, or operable to support a means for receiving, from a workload scheduler device, an indication of a suspension of workload requests associated with a session-oriented workload type in accordance with one or more network congestion metrics.

In some examples, the communication manager 1120 is capable of, configured to, or operable to support a means for transmitting, to a workload scheduler device, information indicative of one or more network congestion metrics associated with a cluster of edge devices including the first host device.

In some examples, the communication manager 1120 is capable of, configured to, or operable to support a means for receiving, from a workload scheduler device, an indication of a suspension of workload requests in accordance with a preemption rate associated with workloads assigned to a cluster of edge devices including the first host device exceeding a threshold preemption rate.

In some examples, the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

In some examples, the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

In some examples, the one or more parameters associated with the workload include a workload type, an indication of an affinity of the workload, a requested completion time, a requested power source or battery power metric, a requested software or hardware capability, one or more weightings associated with the first joint evaluation, or a requested SLA.

In some implementations, the communication manager 1120 may be configured to perform various operations (such as receiving, monitoring, transmitting) using or otherwise in cooperation with the transceiver 1115, the one or more antennas 1125, or any combination thereof. Although the communication manager 1120 is illustrated as a component of the transceiver 1115, in some implementations, one or more functions described with reference to the communication manager 1120 may be supported by or performed by the transceiver 1115, the at least one processor 1140, the at least one memory 1130, the code 1135, or any combination thereof (such as by a processing system including at least a portion of the at least one processor 1140, the at least one memory 1130, the code 1135, or any combination thereof). For example, the code 1135 may include instructions executable by one or more of the at least one processor 1140 to cause the device 1105 to perform various aspects of workload scheduling in edge computing as described herein, or the at least one processor 1140 and the at least one memory 1130 may be otherwise configured to perform or support such operations.

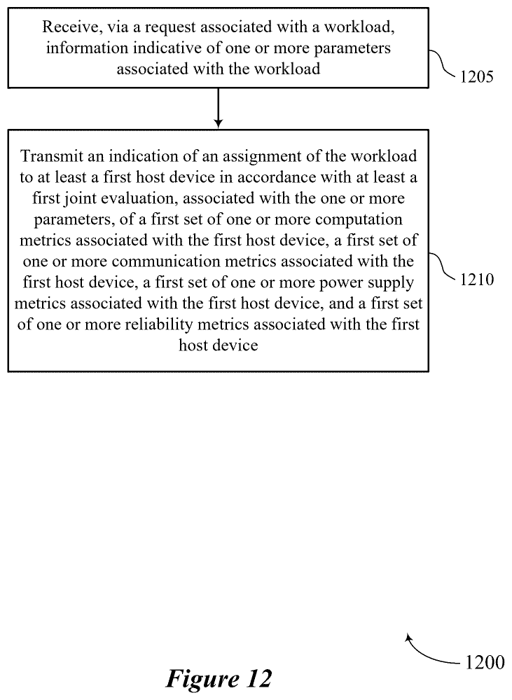

FIG. 12 shows a flowchart illustrating an example method 1200 that supports workload scheduling in edge computing. The operations of the method 1200 may be implemented by a workload scheduler device or its components as described herein. For example, the operations of the method 1200 may be performed by a workload scheduler device or a network entity 105 as described with reference to FIGS. 1-10. In some examples, a workload scheduler device may execute a set of instructions to control the functional elements of the workload scheduler device to perform the described functions. Additionally, or alternatively, the workload scheduler device may perform aspects of the described functions using special-purpose hardware.

At 1205, the method may include receiving, via a request associated with a workload, information indicative of one or more parameters associated with the workload. The operations of 1205 may be performed in accordance with examples as disclosed herein.

At 1210, the method may include transmitting an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device. The operations of 1210 may be performed in accordance with examples as disclosed herein.

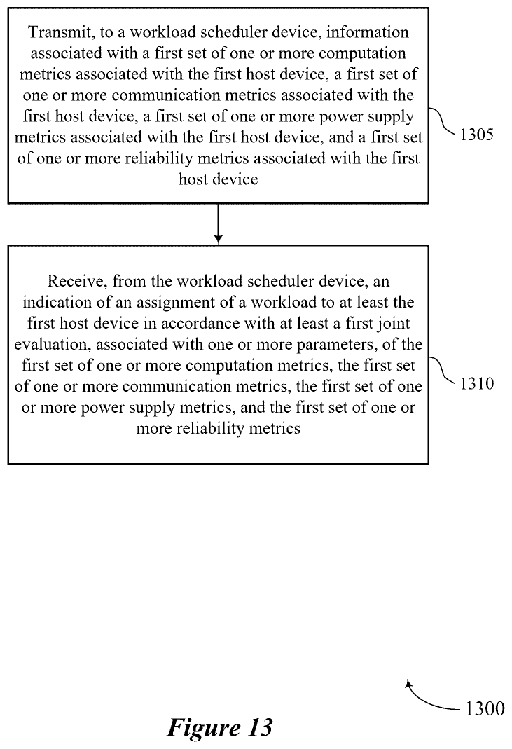

FIG. 13 shows a flowchart illustrating an example method 1300 that supports workload scheduling in edge computing. The operations of the method 1300 may be implemented by a first host device or its components as described herein. For example, the operations of the method 1300 may be performed by a first host device or a network entity 105 as described with reference to FIGS. 1-10. In some examples, a first host device may execute a set of instructions to control the functional elements of the host device to perform the described functions. Additionally, or alternatively, the first host device may perform aspects of the described functions using special-purpose hardware.

At 1305, the method may include transmitting, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device. The operations of 1305 may be performed in accordance with examples as disclosed herein.

At 1310, the method may include receiving, from the workload scheduler device, an indication of an assignment of a workload to at least the first host device in accordance with at least a first joint evaluation, associated with one or more parameters, of the first set of one or more computation metrics, the first set of one or more communication metrics, the first set of one or more power supply metrics, and the first set of one or more reliability metrics. The operations of 1310 may be performed in accordance with examples as disclosed herein.

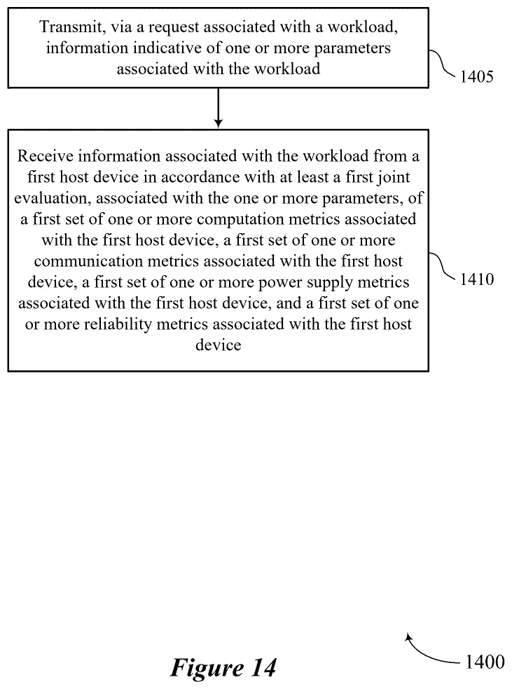

FIG. 14 shows a flowchart illustrating an example method 1400 that supports workload scheduling in edge computing. The operations of the method 1400 may be implemented by a client device (such as a UE) or its components as described herein. For example, the operations of the method 1400 may be performed by a client device or a UE 115 as described with reference to FIGS. 1-9 and 11. In some examples, a client device may execute a set of instructions to control the functional elements of the client device to perform the described functions. Additionally, or alternatively, the client device may perform aspects of the described functions using special-purpose hardware.

At 1405, the method may include transmitting, via a request associated with a workload, information indicative of one or more parameters associated with the workload. The operations of 1405 may be performed in accordance with examples as disclosed herein.

At 1410, the method may include receiving information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device. The operations of 1410 may be performed in accordance with examples as disclosed herein.

### Implementation Examples are Described in the Following Numbered Clauses:

Clause 1: A method for connected edge workload scheduling at a workload scheduler device, including: receiving, via a request associated with a workload, information indicative of one or more parameters associated with the workload; and transmitting an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Clause 2: The method of clause 1, further including: receiving, from the first host device, information associated with the first set of one or more computation metrics, the first set of one or more communication metrics, the first set of one or more power supply metrics, and the first set of one or more reliability metrics.

Clause 3: The method of any of clauses 1-2, further including: obtaining a set of scores for a set of host devices including the first host device in accordance with a respective joint evaluation associated with each host device of a set of host devices, where each score of the set of scores is for a respective host device of the set of host devices, and where the assignment of the workload to at least the first host device is in accordance with a first score for the first host device being relatively greater than one or more scores for a remainder of the set of host devices excluding the first host device.

Clause 4: The method of clause 3, further including: receiving, from each host device of the set of host devices, information associated with a respective set of one or more computation metrics associated with that host device, a respective set of one or more communication metrics associated with that host device, a respective set of one or more power supply metrics associated with that host device, and a respective set of one or more reliability metrics associated with that host device, where the respective joint evaluation associated with each host device of the set of host devices is in accordance with the information received from each host device of the set of host devices.

Clause 5: The method of any of clauses 3-4, where obtaining the set of scores for the set of host devices includes: obtaining the first score for the first host device in accordance with the first joint evaluation; and obtaining a second score for a second host device of the set of host devices in accordance with a second joint evaluation, associated with the one or more parameters, of a second set of one or more computation metrics associated with the second host device, a second set of one or more communication metrics associated with the second host device, a second set of one or more power supply metrics associated with the second host device, and a second set of one or more reliability metrics associated with the second host device, where the first score is relatively greater than the second score.

Clause 6: The method of any of clauses 3-5, where each score of the set of scores is a respective weighted sum of a respective set of one or more computation metrics, a respective set of one or more communication metrics, a respective set of one or more power supply metrics, and a respective set of one or more reliability metrics.

Clause 7: The method of clause 6, where to obtain the respective weighted sum, a first weighting is applied to the respective set of one or more computation metrics, a second weighting is applied to the respective set of one or more communication metrics, a third weighting is applied to the respective set of one or more power supply metrics, and a fourth weighting is applied to the respective set of one or more reliability metrics.

Clause 8: The method of clause 7, further including: obtaining an indication of the first weighting, the second weighting, the third weighting, and the fourth weighting in accordance with historical data associated with workload scheduling across the set of host devices or the one or more parameters associated with the workload.

Clause 9: The method of any of clauses 1-8, further including: obtaining a set of host devices from a set of multiple host devices in association with evaluating each host device of the set of multiple host devices in accordance with the one or more parameters and one or more variants of the workload, where the set of host devices includes the first host device.

Clause 10: The method of clause 9, where evaluating each host device of the set of multiple host devices includes: evaluating whether the workload is feasible for a respective host device of the set of multiple host devices in accordance with the one or more parameters, a respective set of one or more variants of the workload, and a capability of the respective host device.

Clause 11: The method of clause 10, where the capability of the respective host device is associated with one or more percentage metrics associated with an amount of resources used for one or more existing edge compute workloads at the respective host device, one or more memory usage metrics, one or more storage usage metrics, one or more power metrics at the respective host device, a software or hardware capability of the respective host device, or one or more communication metrics associated with over-the-air signaling between the respective host device and a client device associated with the workload.

Clause 12: The method of any of clauses 9-11, further including: including the first host device in the set of host devices in accordance with the workload being feasible for the first host device, where the workload is feasible for the first host device in accordance with the one or more parameters, a first set of one or more variants of the workload, and a first capability of the first host device; and excluding a second host device of the set of multiple host devices from the set of host devices in accordance with the workload being unfeasible for the second host device, where the workload is unfeasible for the second host device in accordance with the one or more parameters, a second set of one or more variants of the workload, and a second capability of the first host device.

Clause 13: The method of any of clauses 1-12, further including: receiving, from the first host device, a rejection of the assignment of the workload to the first host device in accordance with one or more percentage metrics associated with an amount of resources used for one or more edge compute workloads, including the workload, at the first host device exceeding one or more threshold percentages.

Clause 14: The method of clause 13, further including: transmitting an indication of an updated assignment of the workload to at least a second host device in association with receiving the rejection of the assignment of the workload to the first host device.

Clause 15: The method of any of clauses 1-14, further including: receiving information indicating that the first host device is processing edge compute workloads, the edge compute workloads including the workload assigned to the first host device; and transmitting, to the first host device or a first network device associated with the first host device, link configuration information that steers the first host device to the first network device from a second network device in association with the first host device processing the edge compute workloads.

Clause 16: The method of any of clauses 1-15, further including: receiving information indicative of one or more network congestion metrics associated with a cluster of edge devices including the first host device; and transmitting an indication of a suspension of workload requests associated with a session-oriented workload type in accordance with the one or more network congestion metrics.

Clause 17: The method of any of clauses 1-16, further including: receiving information indicating that a preemption rate associated with workloads assigned to a cluster of edge devices including the first host device exceeds a threshold preemption rate; and transmitting an indication of a suspension of workload requests in accordance with the preemption rate exceeding the threshold preemption rate.

Clause 18: The method of any of clauses 1-17, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 19: The method of clause 18, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage associated with the one or more local applications, an indication of one or more existing edge compute workloads, or one or more percentage metrics associated with an amount of resources used for the one or more existing edge compute workloads.

Clause 20: The method of any of clauses 1-19, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 21: A method for connected edge workload scheduling at a first host device, including: transmitting, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device; and receiving, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Clause 22: The method of clause 21, further including: transmitting, to a client device requesting the workload, information associated with the workload in accordance with the assignment of the workload to at least the first host device.

Clause 23: The method of clause 21, further including: transmitting, to the workload scheduler device, a rejection of the assignment of the workload to the first host device in accordance with one or more percentage metrics associated with an amount of resources used for one or more edge compute workloads, including the workload, at the first host device exceeding one or more threshold percentages.

Clause 24: The method of any of clauses 21-23, further including: transmitting, to the workload scheduler device, information indicating that the first host device is processing edge compute workloads, the edge compute workloads including the workload assigned to the first host device; and receiving link configuration information that steers the first host device to a first network device from a second network device in association with the first host device processing the edge compute workloads.

Clause 25: The method of any of clauses 21-24, further including: receiving, from the workload scheduler device, an indication of a suspension of workload requests associated with a session-oriented workload type in accordance with one or more network congestion metrics.

Clause 26: The method of any of clauses 21-25, further including: transmitting, to the workload scheduler device, information indicative of one or more network congestion metrics associated with a cluster of edge devices including the first host device.

Clause 27: The method of any of clauses 21-26, further including: receiving, from the workload scheduler device, an indication of a suspension of workload requests in accordance with a preemption rate associated with workloads assigned to a cluster of edge devices including the first host device exceeding a threshold preemption rate.

Clause 28: The method of any of clauses 21-27, further including: transmitting, to the workload scheduler device, information indicating that a preemption rate at the first host device exceeds a threshold preemption rate.

Clause 29: The method of clause 28, further including: preempting one or more workloads assigned to the first host device in accordance with one or more network changes, cluster exits, higher-priority edge compute workload launches, or local application launches, where transmitting the information indicating that the preemption rate at the first host device exceeds the threshold preemption rate is in association with preempting the one or more workloads.

Clause 30: The method of any of clauses 21-29, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 31: The method of clause 30, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

Clause 32: The method of any of clauses 21-31, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 33: A method for connected edge workload scheduling at a client device, including: transmitting, via a request associated with a workload, information indicative of one or more parameters associated with the workload; and receiving information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Clause 34: The method of clause 33, further including: receiving, from a workload scheduler device, an indication of a suspension of workload requests associated with a session-oriented workload type in accordance with one or more network congestion metrics.

Clause 35: The method of any of clauses 33-34, further including: transmitting, to a workload scheduler device, information indicative of one or more network congestion metrics associated with a cluster of edge devices including the first host device.

Clause 36: The method of any of clauses 33-35, further including: receiving, from a workload scheduler device, an indication of a suspension of workload requests in accordance with a preemption rate associated with workloads assigned to a cluster of edge devices including the first host device exceeding a threshold preemption rate.

Clause 37: The method of any of clauses 33-36, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 38: The method of clause 37, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

Clause 39: The method of any of clauses 33-38, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 40: A workload scheduler device, including: a processing system that includes processor circuitry and memory circuitry that stores code, the processing system configured to cause the workload scheduler device to: receive, via a request associated with a workload, information indicative of one or more parameters associated with the workload; and transmit an indication of an assignment of the workload to at least a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Clause 41: The workload scheduler device of clause 40, where the processing system is further configured to cause the workload scheduler device to: receive, from the first host device, information associated with the first set of one or more computation metrics, the first set of one or more communication metrics, the first set of one or more power supply metrics, and the first set of one or more reliability metrics.

Clause 42: The workload scheduler device of any of clauses 40-41, where the processing system is further configured to cause the workload scheduler device to: obtain a set of scores for a set of host devices including the first host device in accordance with a respective joint evaluation associated with each host device of a set of host devices, where each score of the set of scores is for a respective host device of the set of host devices, and where the assignment of the workload to at least the first host device is in accordance with a first score for the first host device being relatively greater than one or more scores for a remainder of the set of host devices excluding the first host device.

Clause 43: The workload scheduler device of clause 42, where the processing system is further configured to cause the workload scheduler device to: receive, from each host device of the set of host devices, information associated with a respective set of one or more computation metrics associated with that host device, a respective set of one or more communication metrics associated with that host device, a respective set of one or more power supply metrics associated with that host device, and a respective set of one or more reliability metrics associated with that host device, where the respective joint evaluation associated with each host device of the set of host devices is in accordance with the information received from each host device of the set of host devices.

Clause 44: The workload scheduler device of any of clauses 42-43, where, to obtain the set of scores for the set of host devices, the processing system is configured to cause the workload scheduler device to: obtain the first score for the first host device in accordance with the first joint evaluation; and obtain a second score for a second host device of the set of host devices in accordance with a second joint evaluation, associated with the one or more parameters, of a second set of one or more computation metrics associated with the second host device, a second set of one or more communication metrics associated with the second host device, a second set of one or more power supply metrics associated with the second host device, and a second set of one or more reliability metrics associated with the second host device, where the first score is relatively greater than the second score.

Clause 45: The workload scheduler device of any of clauses 42-44, where each score of the set of scores is a respective weighted sum of a respective set of one or more computation metrics, a respective set of one or more communication metrics, a respective set of one or more power supply metrics, and a respective set of one or more reliability metrics.

Clause 46: The workload scheduler device of clause 45, where to obtain the respective weighted sum, a first weighting is applied to the respective set of one or more computation metrics, a second weighting is applied to the respective set of one or more communication metrics, a third weighting is applied to the respective set of one or more power supply metrics, and a fourth weighting is applied to the respective set of one or more reliability metrics.

Clause 47: The workload scheduler device of clause 46, where the processing system is further configured to cause the workload scheduler device to: obtain an indication of the first weighting, the second weighting, the third weighting, and the fourth weighting in accordance with historical data associated with workload scheduling across the set of host devices or the one or more parameters associated with the workload.

Clause 48: The workload scheduler device of any of clauses 40-47, where the processing system is further configured to cause the workload scheduler device to: obtain a set of host devices from a set of multiple host devices in association with evaluating each host device of the set of multiple host devices in accordance with the one or more parameters and one or more variants of the workload, where the set of host devices includes the first host device.

Clause 49: The workload scheduler device of clause 48, where, to evaluate each host device of the set of multiple host devices, the processing system is configured to cause the workload scheduler device to: evaluate whether the workload is feasible for a respective host device of the set of multiple host devices in accordance with the one or more parameters, a respective set of one or more variants of the workload, and a capability of the respective host device.

Clause 50: The workload scheduler device of clause 49, where the capability of the respective host device is associated with one or more percentage metrics associated with an amount of resources used for one or more existing edge compute workloads at the respective host device, one or more memory usage metrics, one or more storage usage metrics, one or more power metrics at the respective host device, a software or hardware capability of the respective host device, or one or more communication metrics associated with over-the-air signaling between the respective host device and a client device associated with the workload.

Clause 51: The workload scheduler device of any of clauses 48-50, where the processing system is further configured to cause the workload scheduler device to: include the first host device in the set of host devices in accordance with the workload being feasible for the first host device, where the workload is feasible for the first host device in accordance with the one or more parameters, a first set of one or more variants of the workload, and a first capability of the first host device; and exclude a second host device of the set of multiple host devices from the set of host devices in accordance with the workload being unfeasible for the second host device, where the workload is unfeasible for the second host device in accordance with the one or more parameters, a second set of one or more variants of the workload, and a second capability of the first host device.

Clause 52: The workload scheduler device of any of clauses 40-51, where the processing system is further configured to cause the workload scheduler device to: receive, from the first host device, a rejection of the assignment of the workload to the first host device in accordance with one or more percentage metrics associated with an amount of resources used for one or more edge compute workloads, including the workload, at the first host device exceeding one or more threshold percentages.

Clause 53: The workload scheduler device of clause 52, where the processing system is further configured to cause the workload scheduler device to: transmit an indication of an updated assignment of the workload to at least a second host device in association with receiving the rejection of the assignment of the workload to the first host device.

Clause 54: The workload scheduler device of any of clauses 40-53, where the processing system is further configured to cause the workload scheduler device to: receive information indicating that the first host device is processing edge compute workloads, the edge compute workloads including the workload assigned to the first host device; and transmit, to the first host device or a first network device associated with the first host device, link configuration information that steers the first host device to the first network device from a second network device in association with the first host device processing the edge compute workloads.

Clause 55: The workload scheduler device of any of clauses 40-54, where the processing system is further configured to cause the workload scheduler device to: receive information indicative of one or more network congestion metrics associated with a cluster of edge devices including the first host device; and transmit an indication of a suspension of workload requests associated with a session-oriented workload type in accordance with the one or more network congestion metrics.

Clause 56: The workload scheduler device of any of clauses 40-55, where the processing system is further configured to cause the workload scheduler device to: receive information indicating that a preemption rate associated with workloads assigned to a cluster of edge devices including the first host device exceeds a threshold preemption rate; and transmit an indication of a suspension of workload requests in accordance with the preemption rate exceeding the threshold preemption rate.

Clause 57: The workload scheduler device of any of clauses 40-56, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 58: The workload scheduler device of clause 57, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage associated with the one or more local applications, an indication of one or more existing edge compute workloads, or one or more percentage metrics associated with an amount of resources used for the one or more existing edge compute workloads.

Clause 59: The workload scheduler device of any of clauses 40-58, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 60: A first host device, including: a processing system that includes processor circuitry and memory circuitry that stores code, the processing system configured to cause the first host device to: transmit, to a workload scheduler device, information associated with a first set of one or more computation metrics associated with the first host device, a first set of one or more communication metrics associated with the first host device, a first set of one or more power supply metrics associated with the first host device, and a first set of one or more reliability metrics associated with the first host device; and receive, from the workload scheduler device, an indication of an assignment of a workload to at least the first host device in accordance with at least a first joint evaluation, associated with one or more parameters associated with the workload, of the first set of one or more computation metrics, the first set of one or more communication metrics, the first set of one or more power supply metrics, and the first set of one or more reliability metrics.

Clause 61: The first host device of clause 60, where the processing system is further configured to cause the first host device to: transmit, to a client device requesting the workload, information associated with the workload in accordance with the assignment of the workload to at least the first host device.

Clause 62: The first host device of clause 60, where the processing system is further configured to cause the first host device to: transmit, to the workload scheduler device, a rejection of the assignment of the workload to the first host device in accordance with one or more percentage metrics associated with an amount of resources used for one or more edge compute workloads, including the workload, at the first host device exceeding one or more threshold percentages.

Clause 63: The first host device of any of clauses 60-62, where the processing system is further configured to cause the first host device to: transmit, to the workload scheduler device, information indicating that the first host device is processing edge compute workloads, the edge compute workloads including the workload assigned to the first host device; and receive link configuration information that steers the first host device to a first network device from a second network device in association with the first host device processing the edge compute workloads.

Clause 64: The first host device of any of clauses 60-63, where the processing system is further configured to cause the first host device to: receive, from the workload scheduler device, an indication of a suspension of workload requests associated with a session-oriented workload type in accordance with one or more network congestion metrics.

Clause 65: The first host device of any of clauses 60-64, where the processing system is further configured to cause the first host device to: transmit, to the workload scheduler device, information indicative of one or more network congestion metrics associated with a cluster of edge devices including the first host device.

Clause 66: The first host device of any of clauses 60-65, where the processing system is further configured to cause the first host device to: receive, from the workload scheduler device, an indication of a suspension of workload requests in accordance with a preemption rate associated with workloads assigned to a cluster of edge devices including the first host device exceeding a threshold preemption rate.

Clause 67: The first host device of any of clauses 60-66, where the processing system is further configured to cause the first host device to: transmit, to the workload scheduler device, information indicating that a preemption rate at the first host device exceeds a threshold preemption rate.

Clause 68: The first host device of clause 67, where the processing system is further configured to cause the first host device to: preempt one or more workloads assigned to the first host device in accordance with one or more network changes, cluster exits, higher-priority edge compute workload launches, or local application launches, where transmitting the information indicating that the preemption rate at the first host device exceeds the threshold preemption rate is in association with preempting the one or more workloads.

Clause 69: The first host device of any of clauses 60-68, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 70: The first host device of clause 69, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

Clause 71: The first host device of any of clauses 60-70, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 72: A client device, including: a processing system that includes processor circuitry and memory circuitry that stores code, the processing system configured to cause the client device to: transmit, via a request associated with a workload, information indicative of one or more parameters associated with the workload; and receive information associated with the workload from a first host device in accordance with at least a first joint evaluation, associated with the one or more parameters, of a first set of one or more computation metrics associated with the first host device, a first set of one or more communication metrics associated with the first host device, a first set of one or more power supply metrics associated with the first host device, and a first set of one or more reliability metrics associated with the first host device.

Clause 73: The client device of clause 72, where the processing system is further configured to cause the client device to: receive, from a workload scheduler device, an indication of a suspension of workload requests associated with a session-oriented workload type in accordance with one or more network congestion metrics.

Clause 74: The client device of any of clauses 72-73, where the processing system is further configured to cause the client device to: transmit, to a workload scheduler device, information indicative of one or more network congestion metrics associated with a cluster of edge devices including the first host device.

Clause 75: The client device of any of clauses 72-74, where the processing system is further configured to cause the client device to: receive, from a workload scheduler device, an indication of a suspension of workload requests in accordance with a preemption rate associated with workloads assigned to a cluster of edge devices including the first host device exceeding a threshold preemption rate.

Clause 76: The client device of any of clauses 72-75, where the first set of one or more computation metrics include one or more CPU metrics, one or more GPU metrics, one or more NPU metrics, one or more memory metrics, or one or more storage metrics; the first set of one or more communication metrics include one or more connectivity metrics, one or more throughput metrics, one or more latency metrics, or one or more link condition metrics; the first set of one or more power supply metrics include one or more power source metrics or one or more battery power metrics; and the first set of one or more reliability metrics include one or more preemption metrics, one or more mobility metrics, or one or more usage metrics.

Clause 77: The client device of clause 76, where the one or more preemption metrics include an indication of a quantity of preemptions associated with network changes, cluster exits, higher-priority edge compute workload launches, or local application launches; the one or more mobility metrics include one or more channel variation metrics, one or more topology change metrics, or one or more cluster exit metrics; and the one or more usage metrics include one or more duration of usage metrics associated with one or more local applications, one or more computation resource usage metrics associated with the one or more local applications, an indication of one or more existing edge compute workloads, or one or more percentage metrics associated with an amount of resources used for the one or more existing edge compute workloads.

Clause 78: The client device of any of clauses 72-77, where the one or more parameters associated with the workload include a workload type, an indication of an affinity of the workload, a requested completion time, a requested power source or battery power metric, a requested software or hardware capability, one or more weightings associated with the first joint evaluation, or a requested SLA.

Clause 79: A workload scheduler device for connected edge workload scheduling, including at least one means for performing a method of any of aspects 1-20.

Aspect 80: A non-transitory computer-readable medium storing code for connected edge workload scheduling, the code including instructions executable by a processing system to perform a method of any of aspects 1-20.

Aspect 81: A first host device for connected edge workload scheduling, including at least one means for performing a method of any of aspects 21-32.

Aspect 82: A non-transitory computer-readable medium storing code for connected edge workload scheduling, the code including instructions executable by a processing system to perform a method of any of aspects 21-32.

Aspect 83: A client device for connected edge workload scheduling, including at least one means for performing a method of any of aspects 33-39.

Aspect 84: A non-transitory computer-readable medium storing code for connected edge workload scheduling, the code including instructions executable by a processing system to perform a method of any of aspects 33-39.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single- or multi-chip processor, a DSP, an ASIC, a GPU, an NPU, an FPGA or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

1. A workload scheduler device, comprising:
a processing system that includes processor circuitry and memory circuitry that stores code, the processing system configured to cause the workload scheduler device to:
receive, via a request associated with a workload, information indicative of one or more parameters associated with the workload; and
transmit an indication of an assignment of the workload to at least a first host device in accordance with at least a first joint evaluation, associated with the one or more parameters, of:
a first set of one or more computation metrics associated with the first host device,
a first set of one or more communication metrics associated with the first host device,
a first set of one or more power supply metrics associated with the first host device, and
a first set of one or more reliability metrics associated with the first host device.

2. The workload scheduler device of claim 1, wherein the processing system is further configured to cause the workload scheduler device to:
receive, from the first host device, information associated with:
the first set of one or more computation metrics,
the first set of one or more communication metrics,
the first set of one or more power supply metrics, and
the first set of one or more reliability metrics.

3. The workload scheduler device of claim 1, wherein the processing system is further configured to cause the workload scheduler device to:
obtain a set of scores for a set of host devices including the first host device in accordance with a respective joint evaluation associated with each host device of a set of host devices, wherein each score of the set of scores is for a respective host device of the set of host devices, and wherein the assignment of the workload to at least the first host device is in accordance with a first score for the first host device being relatively greater than one or more scores for a remainder of the set of host devices excluding the first host device.

4. The workload scheduler device of claim 3, wherein the processing system is further configured to cause the workload scheduler device to:
receive, from each host device of the set of host devices, information associated with:
a respective set of one or more computation metrics associated with that host device,
a respective set of one or more communication metrics associated with that host device,
a respective set of one or more power supply metrics associated with that host device, and
a respective set of one or more reliability metrics associated with that host device,
wherein the respective joint evaluation associated with each host device of the set of host devices is in accordance with the information received from each host device of the set of host devices.

5. The workload scheduler device of claim 3, wherein, to obtain the set of scores for the set of host devices, the processing system is configured to cause the workload scheduler device to:
obtain the first score for the first host device in accordance with the first joint evaluation; and
obtain a second score for a second host device of the set of host devices in accordance with a second joint evaluation, associated with the one or more parameters, of:
a second set of one or more computation metrics associated with the second host device,
a second set of one or more communication metrics associated with the second host device,
a second set of one or more power supply metrics associated with the second host device, and
a second set of one or more reliability metrics associated with the second host device,
wherein the first score is relatively greater than the second score.

6. The workload scheduler device of claim 3, wherein each score of the set of scores is a respective weighted sum of:
a respective set of one or more computation metrics,
a respective set of one or more communication metrics,
a respective set of one or more power supply metrics, and
a respective set of one or more reliability metrics.

7. The workload scheduler device of claim 6, wherein to obtain the respective weighted sum:
a first weighting is applied to the respective set of one or more computation metrics,
a second weighting is applied to the respective set of one or more communication metrics,
a third weighting is applied to the respective set of one or more power supply metrics, and
a fourth weighting is applied to the respective set of one or more reliability metrics.

8. The workload scheduler device of claim 7, wherein the processing system is further configured to cause the workload scheduler device to:
obtain an indication of the first weighting, the second weighting, the third weighting, and the fourth weighting in accordance with historical data associated with workload scheduling across the set of host devices or the one or more parameters associated with the workload.

9. The workload scheduler device of claim 1, wherein the processing system is further configured to cause the workload scheduler device to:
obtain a set of host devices from a plurality of host devices in association with evaluating each host device of the plurality of host devices in accordance with the one or more parameters and one or more variants of the workload, wherein the set of host devices includes the first host device.

10. The workload scheduler device of claim 9, wherein, to evaluate each host device of the plurality of host devices, the processing system is configured to cause the workload scheduler device to:
evaluate whether the workload is feasible for a respective host device of the plurality of host devices in accordance with the one or more parameters, a respective set of one or more variants of the workload, and a capability of the respective host device.

11. The workload scheduler device of claim 10, wherein the capability of the respective host device is associated with one or more percentage metrics associated with an amount of resources used for one or more existing edge compute workloads at the respective host device, one or more memory usage metrics, one or more storage usage metrics, one or more power metrics at the respective host device, a software or hardware capability of the respective host device, or one or more communication metrics associated with over-the-air signaling between the respective host device and a client device associated with the workload.

12. The workload scheduler device of claim 9, wherein the processing system is further configured to cause the workload scheduler device to:
include the first host device in the set of host devices in accordance with the workload being feasible for the first host device, wherein the workload is feasible for the first host device in accordance with the one or more parameters, a first set of one or more variants of the workload, and a first capability of the first host device; and
exclude a second host device of the plurality of host devices from the set of host devices in accordance with the workload being unfeasible for the second host device, wherein the workload is unfeasible for the second host device in accordance with the one or more parameters, a second set of one or more variants of the workload, and a second capability of the first host device.

13-17. (canceled)

18. The workload scheduler device of claim 1, wherein:
the first set of one or more computation metrics include one or more central processing unit (CPU) metrics, one or more graphics processing unit (GPU) metrics, one or more neural processing unit (NPU) metrics, one or more memory metrics, or one or more storage metrics;
the first set of one or more communication metrics include one or more connectivity metrics, one or more throughput metrics, one or more latency metrics, or one or more link condition metrics;
the first set of one or more power supply metrics include one or more power source metrics or one or more battery power metrics; and
the first set of one or more reliability metrics include one or more preemption metrics, one or more mobility metrics, or one or more usage metrics.

19. The workload scheduler device of claim 18, wherein:
the one or more preemption metrics include an indication of a quantity of preemptions associated with network changes, cluster exits, higher-priority edge compute workload launches, or local application launches;
the one or more mobility metrics include one or more channel variation metrics, one or more topology change metrics, or one or more cluster exit metrics; and
the one or more usage metrics include one or more duration of usage metrics associated with one or more local applications, one or more computation resource usage associated with the one or more local applications, an indication of one or more existing edge compute workloads, or one or more percentage metrics associated with an amount of resources used for the one or more existing edge compute workloads.

20. The workload scheduler device of claim 1, wherein the one or more parameters associated with the workload include a workload type, an indication of an affinity of the workload, a requested completion time, a requested power source or battery power metric, a requested software or hardware capability, one or more weightings associated with the first joint evaluation, or a requested service level agreement (SLA).

21. A first host device, comprising:
a processing system that includes processor circuitry and memory circuitry that stores code, the processing system configured to cause the first host device to:
transmit, to a workload scheduler device, information associated with:
a first set of one or more computation metrics associated with the first host device,
a first set of one or more communication metrics associated with the first host device,
a first set of one or more power supply metrics associated with the first host device, and
a first set of one or more reliability metrics associated with the first host device; and
receive, from the workload scheduler device, an indication of an assignment of a workload to at least the first host device in accordance with at least a first joint evaluation, associated with one or more parameters, of:
the first set of one or more computation metrics,
the first set of one or more communication metrics,
the first set of one or more power supply metrics, and
the first set of one or more reliability metrics.

22. The first host device of claim 21, wherein the processing system is further configured to cause the first host device to:
transmit, to a client device requesting the workload, information associated with the workload in accordance with the assignment of the workload to at least the first host device.

23. The first host device of claim 21, wherein the processing system is further configured to cause the first host device to:
transmit, to the workload scheduler device, a rejection of the assignment of the workload to the first host device in accordance with one or more percentage metrics associated with an amount of resources used for one or more edge compute workloads, including the workload, at the first host device exceeding one or more threshold percentages.

24. The first host device of claim 21, wherein the processing system is further configured to cause the first host device to:
transmit, to the workload scheduler device, information indicating that the first host device is processing edge compute workloads, the edge compute workloads including the workload assigned to the first host device; and
receive link configuration information that steers the first host device to a first network device from a second network device in association with the first host device processing the edge compute workloads.

25. The first host device of claim 21, wherein the processing system is further configured to cause the first host device to:
receive, from the workload scheduler device, an indication of a suspension of workload requests associated with a session-oriented workload type in accordance with one or more network congestion metrics.

26. The first host device of claim 21, wherein the processing system is further configured to cause the first host device to:
transmit, to the workload scheduler device, information indicative of one or more network congestion metrics associated with a cluster of edge devices including the first host device.

27. The first host device of claim 21, wherein the processing system is further configured to cause the first host device to:
receive, from the workload scheduler device, an indication of a suspension of workload requests in accordance with a preemption rate associated with workloads assigned to a cluster of edge devices including the first host device exceeding a threshold preemption rate.

28. The first host device of claim 21, wherein the processing system is further configured to cause the first host device to:
transmit, to the workload scheduler device, information indicating that a preemption rate at the first host device exceeds a threshold preemption rate.

29-39. (canceled)

40. A method for connected edge workload scheduling at a workload scheduler device, comprising:
receiving, via a request associated with a workload, information indicative of one or more parameters associated with the workload; and
transmitting an indication of an assignment of the workload to at least a first host device in accordance with at least a first joint evaluation, associated with the one or more parameters, of:
a first set of one or more computation metrics associated with the first host device,
a first set of one or more communication metrics associated with the first host device,
a first set of one or more power supply metrics associated with the first host device, and
a first set of one or more reliability metrics associated with the first host device.

41-51. (canceled)

52. The method of claim 40, further comprising:
receiving, from the first host device, a rejection of the assignment of the workload to the first host device in accordance with one or more percentage metrics associated with an amount of resources used for one or more edge compute workloads, including the workload, at the first host device exceeding one or more threshold percentages.

53. The method of claim 52, further comprising:
transmitting an indication of an updated assignment of the workload to at least a second host device in association with receiving the rejection of the assignment of the workload to the first host device.

54. The method of claim 40, further comprising:
receiving information indicating that the first host device is processing edge compute workloads, the edge compute workloads including the workload assigned to the first host device; and
transmitting, to the first host device or a first network device associated with the first host device, link configuration information that steers the first host device to the first network device from a second network device in association with the first host device processing the edge compute workloads.

55. The method of claim 40, further comprising:
receiving information indicative of one or more network congestion metrics associated with a cluster of edge devices including the first host device; and
transmitting an indication of a suspension of workload requests associated with a session-oriented workload type in accordance with the one or more network congestion metrics.

56-59. (canceled)

60. A method for connected edge workload scheduling at a first host device, comprising:
transmitting, to a workload scheduler device, information associated with:
a first set of one or more computation metrics associated with the first host device,
a first set of one or more communication metrics associated with the first host device,
a first set of one or more power supply metrics associated with the first host device, and
a first set of one or more reliability metrics associated with the first host device; and
receiving, from the workload scheduler device, an indication of an assignment of a workload to at least the first host device in accordance with at least a first joint evaluation, associated with one or more parameters, of:
the first set of one or more computation metrics,
the first set of one or more communication metrics,
the first set of one or more power supply metrics, and
the first set of one or more reliability metrics.

61. The method of claim 60, further comprising:
transmitting, to a client device requesting the workload, information associated with the workload in accordance with the assignment of the workload to at least the first host device.

62-78. (canceled)
